(19) United States
(12) Patent Application Publication
(10) Pub. No.: US 2012/0007708 A1
(43) Pub. Date: Jan. 12, 2012

(54) SOLID STATE ROTARY FIELD ELECTRIC POWER COGENERATION UNIT

(75) Inventor: Robert Ray Holcomb, Nokomis, FL (US)

(73) Assignee: Redemptive Technologies Limited, Road Town Tortola (VG)

(21) Appl. No.: 13/143,775

(22) PCT Filed: Jan. 12, 2010
(86) PCT No.: PCT/IB2010/000039

§ 371 Date: Oct. 3, 2011

Related U.S. Application Data
(60) Provisional application No. 61/204,861, filed on Jan. 12, 2009.

(51) Int. Cl. H01F 27/30

(52) U.S. Cl. 336/195

(57) ABSTRACT

A solid state rotary filed electric power cogeneration unit and method is disclosed for converting a portion of the flowing current (electrons) in the neutral leads of any alternating electric power system into usable electric power (energy) without negatively changing the power status of the primary or power side of the system and simultaneously effecting more efficient functioning of the neutral and/or ground neutral portion of the system by lowering the impedance.

### FIELD OF THE INVENTION

The method and apparatus of the present invention relates generally to a solid state electric power transmission cogeneration unit. More particularly the present invention relates to the various embodiments of a system in which electric power is generated by a solid state rotary field electric power cogeneration unit which has no moving parts.

### BACKGROUND

The earth upon which we live has existed for an unknown number of years. It is safe to say that man has resided upon the earth for thousands to millions of years. Only over the past four hundred years, man has begun to destroy the very earth upon which he lives and depends for all of his life support services. Man is using large amounts of the exhaustible energy from the earth, largely in the form of fossil fuels. We are rapidly depleting our energy resources, polluting the environment and increasing global warming. We need an alternative energy supply. In addition to the environmental impact of man's reliance on fossil fuels, the economic impact is spinning out of control.

The need for power generation units which do not destroy or adversely impact the energy equilibrium of the earth for an infinite period of time is obvious. If one looks at all of the renewable sources of energy available, each one has significant problems of availability, reliability and expense. Such resources are solar, wind, hydroelectric, electrostatic, geothermal, temperature differential and gravity.

There is a need for another source for power. There is thus a need for an electric power cogeneration process.

### SUMMARY

An aspect of the invention is an electric power cogeneration unit for receiving and converting a portion of a flowing current from an alternating electric power system into usable electric power, the cogeneration unit comprising a cogeneration unit core having a plurality of slots formed along an external surface of the core; and a plurality of electromagnetic poles with windings of induction power generation coils are formed in the slots of the core arranged for receiving the power generation coils, wherein the induction coils and electromagnetic poles are connected and arranged in a pattern and sequenced to receive and convert the current into usable electric power.

An aspect of the invention is a method of electric power cogeneration unit for receiving and converting a portion of a flowing current from an alternating electric power system into usable electric power, the method comprising providing a cogeneration unit core having a plurality of slots formed along an external surface of the core; and arranging a plurality of electromagnetic poles with windings of induction power generation coils are formed in the slots of the core arranged for receiving the power generation coils, wherein the induction coils and electromagnetic poles are connected and arranged in a pattern and sequenced to receive and convert the current into usable electric power.

Embodiments of the invention provide a method of converting a portion of the flowing current (electrons) in the neutral leads of any alternating electric power system into usable electric power (energy) without negatively changing the power status of the primary or power side of the system and simultaneously effecting more efficient functioning of the neutral and/or ground neutral portion of the system by lowering the impedance.

In an embodiment, the core further comprises a metal material on the external surface of the core where the metal material may be a laminate sheet that is shaped onto the core. The metal material is insulation coated electrical steel M-15 or M-19 (29-gauge or 26-gauge) onto a circular shaped core.

In an embodiment, the core may comprise any number of slots, for example 36 wire slots. It will be appreciated that there may be more than or less than 38 wire slots, and the plurality of wire slots may be formed on the inner or outer radius surface of the core. The core stator may be supported by a support means. The flowing current from the alternating electric power system is received in the neutral leads, and the induction coils may be arranged so that they are in the sequence and pattern to allow the generation of single phase, 2 phase or 3 phase power alternating current. Also, alternating current is used operate DC (direct current) equipment by routing the output from the induction coils through a bridge rectifier (a full wave rectifier) but not limited to such a full wave rectifier. The core stator is a soft Iron (cast iron) or laminated steel excitation pole material which may be wound in the appropriate and desired direction with the conduit carrying the neutral load current. The excitation pole core may end in direct proximity to an induction coil within the appropriate portion of the coil slots of the induction power generation coils. The wound pole cores which form the electromagnetic poles may be wound such that at lest two north poles fire in sequence in a clockwise fashion over each slot of the superior portion of the power generation coils. The current conduit neutral that carries the current from the outflow of the north poles may then traverses to the electromagnetic poles which are embedded within the slots of the inferior portion of the power generation coils. The winding of the electromagnetic poles which are embedded within the slots of the inferior portion of the power generation coils may be wound in the opposite direction in reference to the pole coils over the superior portion of the power generation coils such that these poles embedded into the inferior wire slots are south pole wound and also fire in sequence in a clockwise fashion. The firing may be sequenced of the north pole—south pole sequence which generates power in the power generation coils by induction just as a magnetized spinning rotor or armature generates power. During the powering of the electromagnetic pole cores, the three (3) electromagnetic poles fire in sequence by using the two or three legs (lines) of a three (3) phase current supply (AC or pulsed DC current). The sequence of energizing the electromagnetic poles, the first electromagnetic pole is energized and the 2^{nd} (second) is energized 60°, but not limited to 60°, later with the 3^{rd} (third) being energized 60° but not limited to 60°, after the energizing of the 2^{nd} (second electromagnetic pole. The 2^{nd} (second) 180° (electrical degrees) of the 3 phase cycle the pole coils may be of opposite polarity. The sequencing allows the induction coils in the stator to see a spinning moving magnetic field of a solid state armature.

In an embodiment only single phase electric power is available the frequency of the electromagnetic poles is separated by the use of capacitor banks. The single phase neutral current is fed to electromagnetic pole #1 and electromagnetic pole #3 is fed out of the same single phase service as in pole #1 but prior to entering pole #3 the current is passed through a capacitor bank such that the voltage and current are retarded by an additional phase angle shift. The spinning armature of the solid state, non-moving, rotating field generator experiences no electromagnetic drag from the magnetic “Reaction Force” created by the load that opposes the rotation of the armature in the classic generator. An embodiment of the present invention describes a new method of cogeneration of electric power from the neutral or ground neutral power of single-phase or three-phase systems. The neutral leg of the transmission system is diverted through the system. The current carrying conduit is wound around magnetic pole iron which is implanted into the slots of a power co-generation generator in such a fashion that north pole/south pole sequencing occurs around the 360° of the system and generates power in the power generation coils just as a magnetized spinning armature generates power.

Therefore, it is the principal object of an embodiment of the present invention to present a method of diverting the neutral leg transmitted power through a power cogeneration unit to produce additional power with no loss of the transmitted power, nor impedance to neutral or ground neutral current flow. Taking power off the neutral leg will actually decrease impedance thereby allowing normal current flow in the power leg or legs.

It is an additional object of an embodiment of the present invention to reveal the method by which the neutral leg of a power transmission system is used to generate additional power and the power leg may or may not bypass the system, therefore no load is involved and no energy lost in the system so long as impedance is at a minimum such that ground flow is not impeded. Taking power off the neutral in the system allows more efficient function of the neutral.

It is an additional object of an embodiment of the present invention to demonstrate that the system causes insignificant impedance within the neutral conduit.

It is a further object of an embodiment of the present invention to reveal the various embodiments which may utilize the basic technology to produce electric energy for multiple applications.

It is an additional object of an embodiment of the present invention to reveal the various structure and dimensions of the laminated iron core of the generator as it is currently understood.

It is a further object of an embodiment of the present invention to reveal the placement and structure of the power generation stator coils for single phase power and three phase power. Three phase neutral transmission lines are rare and if they are used, all three power legs are made up to one neutral line. This neutral may be used in a similar fashion to a single phase neutral.

It is an additional object of an embodiment of the present invention to reveal the winding formulas of the stator (collector) coils as related to the generator iron core and the power generation pole structure.

It is a further object of an embodiment of the present invention to reveal and describe the structure and function of the generator pole iron of the current invention as well as sizing of the pole iron in reference to power generation efficiency.

It is an additional object of an embodiment of the present invention to reveal and describe the winding formula and method for winding the power generation poles which transmit the neutral current through the system which is passing through from an outside source.

It is a further object of an embodiment of the present invention to reveal and describe the sequencing of the hook-up as it relates to the frequency delay in each leg of the two or three legs of a three-phase power transmission system. Each of the legs are neutral conduits from the power transmission system which is passing neutral current through the cogeneration system. The formula will be presented for the cogeneration of single phase and three phase power. The application of this data will also be explained.

It is a further object of an embodiment of the present invention to reveal the benefit of super-conductor coils for the power generating poles.

It is an additional object of an embodiment of the present invention to reveal multiple opportunities for placement of the cogeneration system within any power system, including on the neutral side of an external “WYE” connection of three phase generators and electric motors.

### BRIEF DESCRIPTION OF THE DRAWINGS

In order that embodiments of the invention may be fully and more clearly understood by way of non-limitative examples, the following description is taken in conjunction with the accompanying drawings in which like reference numerals designate similar or corresponding elements, regions and portions, and in which:

FIG. 1 is a representation of an end view of the laminated steel stator core used for one embodiment of the invention;

FIG. 2 is a representation of a lateral view of the laminated steel stator core in FIG. 1 above;

FIG. 3 is a representation of the embodiment from FIG. 1 and FIG. 2 which contains the generating pole iron of an embodiment of the invention;

FIG. 3a-b is a representation of the pole iron of an embodiment of the invention upon which the pole generating coils are wound;

FIG. 4 is a representation of the wound coils of the induction field of an embodiment of the embodiment depicted in FIG. 1, FIG. 2 and FIG. 3;

FIG. 5 is a representation of the wound coils of the induction field along with the wound coils of the generating poles of the embodiment depicted in FIG. 1, FIG. 2 and FIG. 3;

FIG. 6 is a representation of the wiring connections of the power generating poles of an embodiment of the invention for embodiments depicted in FIG. 1, FIG. 2 and FIG. 3;

FIG. 6a is a representation of the pattern of the separate phases of three phase power with an indicator of the sequencing of phases 1 through 3;

FIG. 7 is a representation of an end view of the laminated steel stator core used for the 2^{nd} I embodiment of the invention;

FIG. 8 is a representation of a lateral view of the laminated steel stator core in FIG. 7 above;

FIG. 9 is a representation of the embodiment from FIG. 7 and FIG. 8 which contains the generating pole iron of an embodiment of the invention;

FIG. 10 is a representation of the wound coils of a single phase induction field of the embodiment depicted in FIG. 7, FIG. 8 and FIG. 9;

FIG. 11 is a representation of the wound coils of a single phase induction field along with the wound coils of the generator poles of the embodiment depicted in FIG. 7, FIG. 8, FIG. 9 and FIG. 10;

FIG. 12 is a representation of the wiring schematics for power generation by the cogeneration unit of an embodiment of the invention, resulting in 1) single phase power and 2) three phase power;

FIG. 12a is a representation of curves illustrating the voltage variations in a three phase machine. One cycle of rotation produces 1 Hz of alternating current;

FIG. 13 is a representation of a single phase power cogeneration unit in which the energy generated by the pole coils is collected from both the north pole and south pole energy so that the electric power generated is more than doubled in comparison to units which capture the energy from only one pole. The input power is a neutral leg of a three phase electric generator, electric motor or other appliance made up in a “WYE” connection; and

FIG. 14 is a diagrammatic representation of the test circuit conduit used to test the second generation prototype.

### DETAILED DESCRIPTION

The method and apparatus of the present invention relates to a solid state electric power transmission cogeneration unit. More particularly embodiments of the present invention relates to the various embodiments of a system in which electric power is generated by a solid state rotary field electric power cogeneration unit which has no moving parts, therefore it is more stable, durable, and efficient. The system operates by the diversion of the power neutral or ground neutral conduit of an AC (alternating current) power transmission system through a solid state power cogeneration apparatus. The feed or power hot line from the transmission system does not enter the apparatus. During the transit through the cogeneration apparatus the current carrying conduit exhibits equal or less impedance than if it were a mere standard conduit outside of the unit. This is accomplished by increasing the size of the conductors through the unit such that impedance will not be an inhibiting factor. The neutral or ground neutral wire carrying the current load is wound onto appropriate cast iron or laminated steel cores which are placed in direct proximity to the coil slots, of power generation coils which are wound into the appropriate slots of a laminated steel generator frame. The coils are formed of multiple coils per group with multiple groups being used as needed. The wound iron pole coils form electromagnetic poles which are wound such that three or more north-wound poles fire in sequence in a clockwise fashion into each slot of the superior portion of the power generation coils. The neutral current carrying conduit then traverses to the electromagnetic poles which are seated into the slots of the inferior portion of the power generation coils. These pole coils are wound in the opposite direction in reference to the pole coils over the superior portion of the power generation coils. The south-pole wound poles also fire in sequence in a clockwise fashion. The sequential firing of the north pole—south pole sequence generates power in the power generation coils just as a magnetic spinning armature generates power. The electromagnetic poles fire in sequence by using two or three legs (lines) of a three (3) phase AC power supply (phase A, B and C). Thereby the first electromagnetic pole is energized and the second is energized 60° later, with the third being energized 60° after the second electromagnetic pole. In some applications only poles #1 and #3 are used. If only single phase power is available the frequency of the current flowing through the magnetic poles is controlled with capacitor banks on leads two and three. The single phase current is fed to lead of magnet #1; a second single phase line is fed through a capacitor such that the voltage and current are retarded by 90° in magnet #3 with respect to magnet #1.

Unlike the spinning armature type generator, this solid state non-moving generator experiences no electromagnetic drag from the magnetic “Reaction Force” created by the load current that opposes the rotation of the armature. Cogeneration along neutral transmission lines or at an end user location of neutral or ground neutral would provide significant power. Another major application involves making up the “WYE” connection of a three-phase generator or three-phase electric motor through the unit.

The cogeneration power unit of an embodiment of the current invention operates by the diversion of the neutral or ground neutral leg of a power system through the solid state cogeneration apparatus. Neutral transmission lines are mostly confined to single phase. The three phase applications are mostly confined to the neutral side of a “WYE” connection of either a three phase generator, electric motor or other appliance. The unit only works with AC or pulsed DC current. The hot wire from the transmission system does not enter the cogeneration apparatus in the single phase application. During the transit through the cogeneration apparatus, the neutral wire experiences no increased impedance because the circular mils are increased in proportion to demand. The wire carrying the current load is wound onto appropriate soft iron (cast iron) or laminated steel cores. The pole ends are placed in direct proximity to the coil within the appropriate portion of the coil slots of the induction power generation coils. These power generation coils are wound into the appropriate slots of a laminated steel generator core. The coils are formed of multiple groups being used as appropriate. The wound pole cores form electromagnetic poles which are wound such that two, three or more north poles fire in sequence in a clockwise fashion over each slot of the superior portion of the power generation coils. This current neutral carrying conduit then traverses to the electromagnetic poles which are embedded within the slots of the inferior portion of the power generation coils. The pole coils within the inferior generation coil slots are wound in the opposite direction in reference to the pole coils over the superior portion of the power generation coils. These poles also fire in sequence in a clockwise fashion. The sequential firing of the north pole—south pole sequence generates power in the power generation coils by induction just as a magnetized spinning armature generates power. The three (3) electromagnetic poles fire in sequence by using the two or three legs (lines) of a three (3) phase current supply of AC current. The first electromagnetic pole is energized and the 2^{nd} (second) is energized 60° later with the third being energized 60° after the second electromagnetic pole. This allows the induction coils to see a spinning, moving magnetic field, i.e. a solid state armature. For the 2^{nd} 180° cycle the poles are of opposite polarity due to the AC current cycle.

If only single phase power is available the frequency of the electromagnetic poles is controlled by the use of capacitor banks. The single phase current is fed to electromagnetic pole #1 and electromagnetic pole #3 is fed out of the same single phase service as in pole #1 through a capacitor bank in series such that the voltage and current are retarded by an additional shift in phase angle. Unlike the spinning armature this solid state, non-moving, rotating field generator experiences no electromagnetic drag from the magnetic “Reaction Force” created by the load current that opposes the rotation of the armature in the classic generator.

Every atom has a nucleus composed of positively charged protons and uncharged neutrons. Negatively charged electrons orbit the nucleus. In most atoms, the number of electrons is equal to the number of protons in the nucleus, so that there is no net charge. If the number of electrons is less than the number of protons, then the atom has a net positive charge. If the number of electrons is greater than the number of protons, then the atom has a net negative charge. Within the universe, there is electrical neutrality; however there are local concentrations of charge throughout biological and physical systems. These local concentrations are responsible for all electrical activity. In the universe not all electrons are involved in the structure of material; there are vast numbers of electrons “at large” which are in equilibrium with the outer shell electrons of atoms in the universe. It is from this pool of electrons which are in equilibrium with the outer shell electrons in conductor coils along with free electrons in the earth (ground) that electric current is generated. Electrons in motion constitute an electric current. The electrons that move are outer shell electrons and electrons “at large” which are in equilibrium with the outer shell electrons. A wire connected to a DC power source will cause electrons to flow through the wire in a manner similar to the way water flows through a pipe. This means that the path of any one electron essentially can be anywhere within the volume of the wire (i.e. center, middle, radius or surface.) When a high frequency AC voltage is applied across a wire it will cause electrons to vibrate back and forth. In the vibrating process, the electrons will generate magnetic fields. These magnetic fields push electrons toward the surface of the wire. As the frequency of the applied current increases, the electrons are pushed further away from the center and toward the surface. In the process the center region of the wire becomes devoid of conducting electrons. With continued increased frequency, an electron cloud will form around the surface. The flow of electrons in this cloud is similar to the flow of electrons in a super conductor, in that there is very little resistance to flow. Embodiments of the present invention utilizes the magnetic field emitted by flowing transmitted power which is discharging through a load back to the neutral to generate additional power without any increase in impedance of the transmitted power when the conductors are of appropriate size. When superconductor material is used in the “pole coils” of embodiments of the present invention the efficiency and therefore the total amount of co-generated power will greatly increase. Some increased efficiency could be attained by placing the unit in a housing containing liquid CO2 or liquid nitrogen.

The above overview of embodiments of the current invention will be further described by a detailed description of the sequential construction of the unit followed by a reiteration of the functioning of the device.

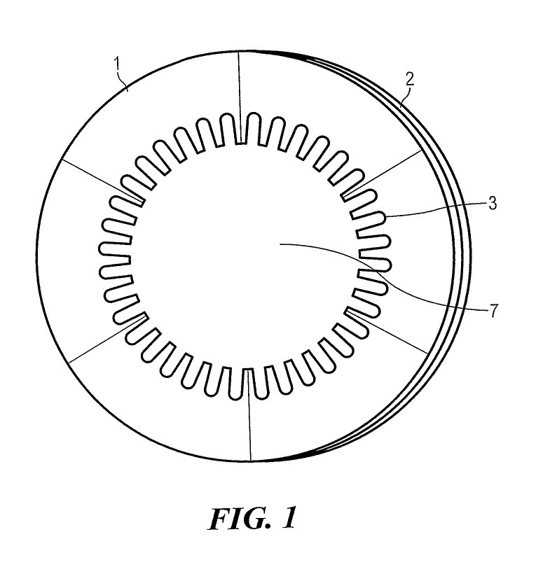

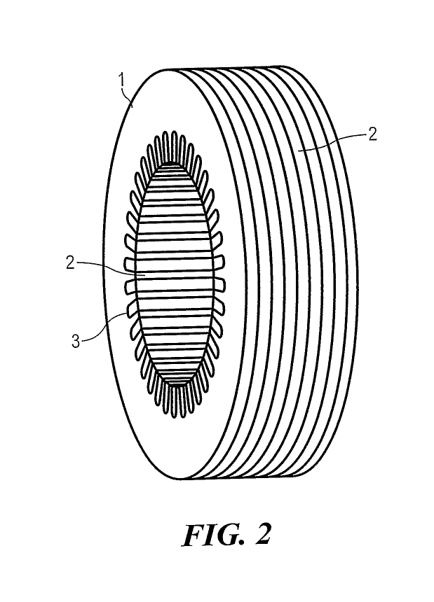

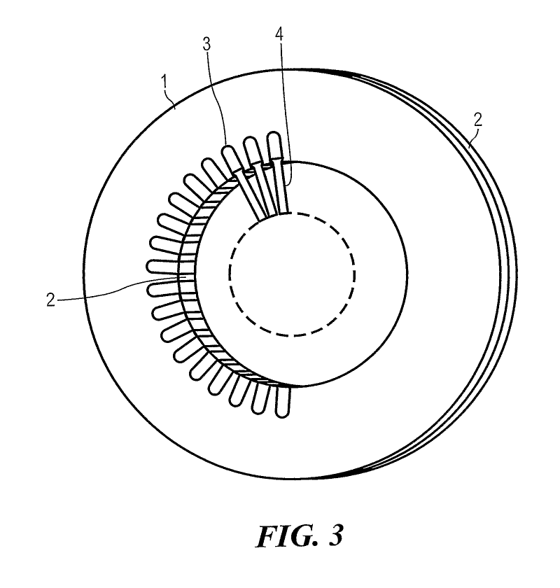

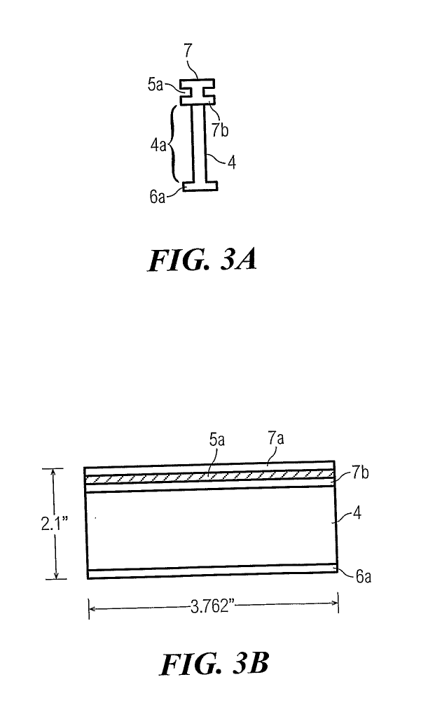

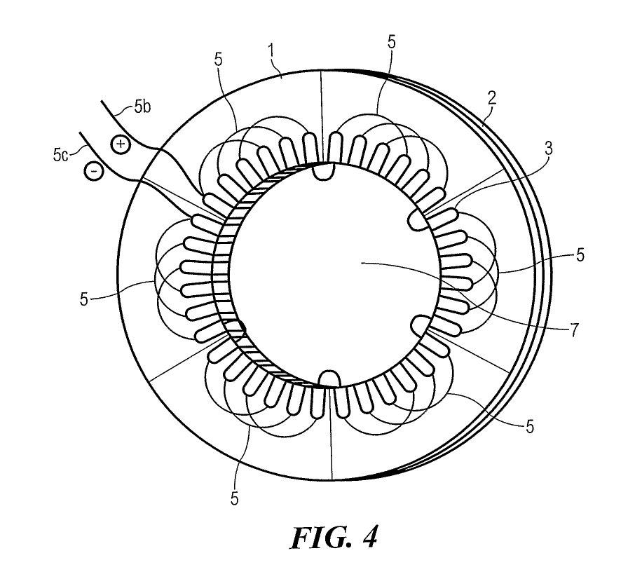

Turning to the Figures, reference is first made to FIG. 1, where there is illustrated a laminated circular steel core 1 of the device with a center hole 7 and open slots 3 which are cut to the proper width and depth to contain the wire of the power induction coils. The size of the structure and the thickness of the laminate 2 as well as the overall size of the core is altered according to specific requirements. FIG. 2 is a lateral view of the laminated steel core 1 which reveals the laminate 2 and the wire slots 3. FIG. 3 is a representation of the laminated core 1 which reveals the laminate 2, wire coil slots and electromagnetic pole iron 4. The pole iron 4 represents the core upon which the large gauge induction conduits through which the neutral or ground neutral current travels is wound. FIG. 3a-b represents the pole iron 4 in a lateral and end projection. The center portion (the body) 4a is insulated and the large gauge magnet wire is wrapped in the appropriate direction and for the appropriate number of turns. The groove 5a is in the proximal end is slid into the winding slots such that flat surface 7 is slid on top of the slot wedge inside the wire slot which is full of wound magnetic wire. The groove 5a is slid between two teeth of the wire slot. The wire which is wound around the pole iron is retained by end pieces 6a and 7b of FIG. 3a. FIG. 4 represents the laminated steel core 1 which contains slot insulation and the induction coils 5 wound and laid in with the formula 3 coils to a group, coil #1 laid in slots 1 and 4, coil #2 laid in slots 2 and 5 and coil #3 laid in slots 3 and 6. The coils 5 are made up in series FIG. 4 with 5b being positive or neutral and 5c being negative or power lead.

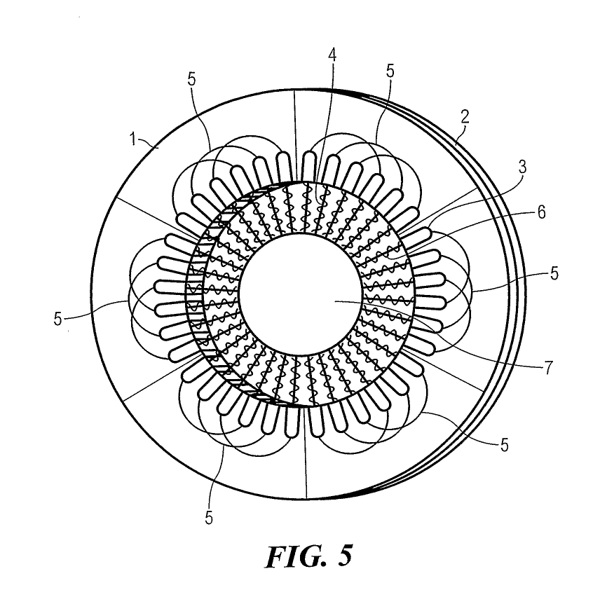

FIG. 5 is a representation of the laminated steel core 1 of an embodiment of the invention containing induction coils 5 laid into slots 3. The pole iron 4 which is wound with the current conduit 6 which enters the system from a power transmission conduit neutral or ground neutral and then exits back to the power transmission conduit or to ground.

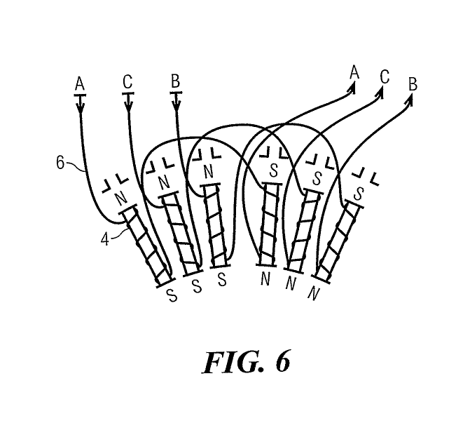

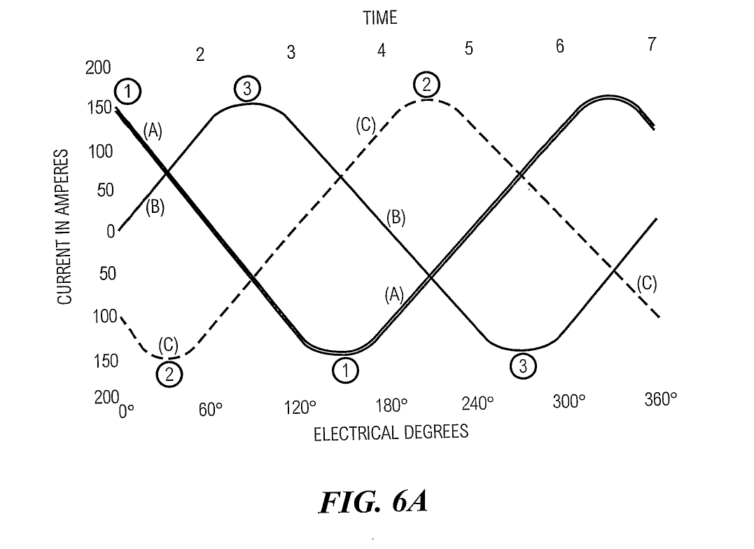

FIG. 6 is a representation of the pole iron 4 (FIG. 3a-b) wound with the insulated copper magnet wire 6 of the proper size which conducts current from the three (3) power legs (phase A, phase B and phase C) of the input of the power neutral lines of a three phase generator or electric three phase motor with external “WYE” connection. The current flows through the copper magnet wire and makes up through a “WYE” connection without loss of power within the power cogeneration system. The pole electromagnets as depicted in FIG. 6 are wound such that as the six poles are placed within the six slots of the three induction coils of an embodiment of the invention, the superior three poles are wound to produce north poles in the slots and the inferior three poles are wound so as to produce south poles in the slots. A north pole in the slot is produced by winding the coil counter clockwise with respect to current flow as one is looking down on top of the pole (i.e. the end away from the coil slot). A south pole in the slot is produced by winding the coil clockwise looking down on top of the pole (i.e. the end away from the coil slot). The polarity is determined by use of the left-hand rule to determine polarity in an electromagnet. The induction coils 5 in each group generate single phase alternating current, either 60 cycle or 50 cycle, depending upon the frequency of the three phase current. The induction coils generate power due to the moving magnetic field which moves past them. North poles move over the superior portion of the coils as south poles move over the inferior portion of the coils. This moving field revolves repeatedly in a clockwise fashion by the following mechanism as represented in FIG. 6. Phase 1 current is fed to the coils of the pole 4/1, which are wound in a counter-clockwise fashion as one is looking down on top of the pole forming a north pole. The copper magnet wire then leaves 4/1 and makes up with the coil wound onto 4/4. This however forms a south pole by the magnet wire being wound clockwise as one is looking down on the top of the magnetic pole. The magnet wire from the end of coil 4/4 then connects with 4/1 coil of the adjoining group of induction coils, moving in a clockwise fashion. Phase C current (which lags phase A current by 60°) is fed to 4/2 pole coils which are wound in a clockwise fashion as one is looking down on top of the pole. As will be noted in FIG. 6a, the 3-phase power lines A, B, and C are utilized to allow north pole and south pole pulses to be generated 60 times per second. Three north poles are allowed to fire in sequence by winding the first pole for north pole in the slot when the A phase is positive, winding the second pole in the opposite direction fed by phase C which is negative and wire the third pole just as the first and feed phase B which peaks positive (phase A peaks positive), phase C peaks negative followed by phase B which peaks last and positive. This sequence then reverses for the next 180° and repeats 60 times per second. Therefore there is sequential activation of N N N and S S S. The copper magnet wire leaves the end of the coil 4/2 and makes up with the coil wound onto 4/5. The winding on 4/5 forms a south pole by the magnet wire being wound counterclockwise as one is looking down on the top of the magnet pole, thereby generating a south pole in the wire slot. The magnet wire from the end of coil 4/5 then connects with 4/2 coil of the adjoining group of induction coils moving in a clockwise fashion around the wound laminated steel generator as in FIG. 5. Phase B current (which lags Phase C current by 60°) is fed to 4/3 pole coils which are wound in a counterclockwise fashion as one is looking down on top of the pole. This counterclockwise winding induces a north pole in the wire slot. The copper magnet wire leaves the end of the coil 4/3 and makes up with the coil wound onto 4/6. The winding on 4/6 forms a south pole by the magnet wire being wound clockwise as one is looking down on the top of the magnetic pole thereby generating a south pole in the corresponding wire slot. The copper magnet wire from the end of coil 4/6 then connects with 4/3 coil of the adjoining group of induction coils, moving in a clockwise fashion around the insulated and wound laminated steel generator as in FIG. 5. When all six groups of induction coils (FIG. 5) are connected as in the above fashion, a rotating, alternating pole magnetic effect will continuously cycle to the right resulting in a generator effect essentially identical to the effect of a rotating armature generator. This cogeneration system causes no additional impedance of the current passing through the pole coils, but generates an additional 10% plus of the power flowing in the neutral of the “WYE” connected generator, electric motor or other appliance.

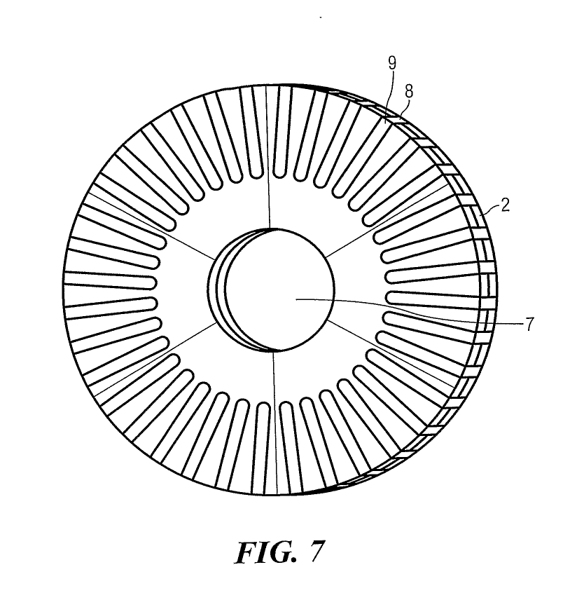

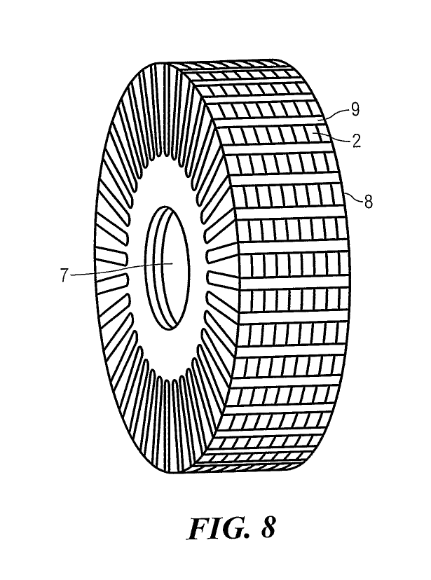

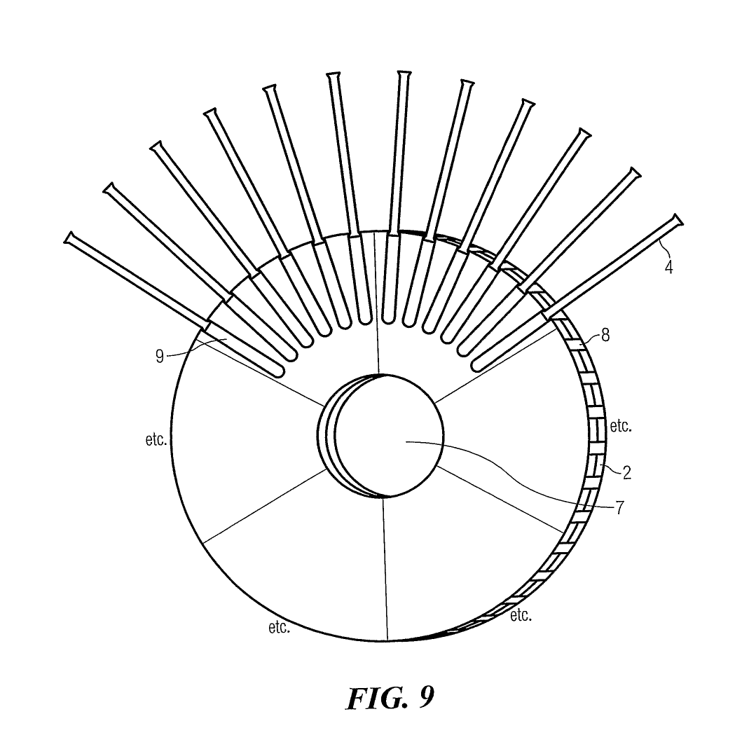

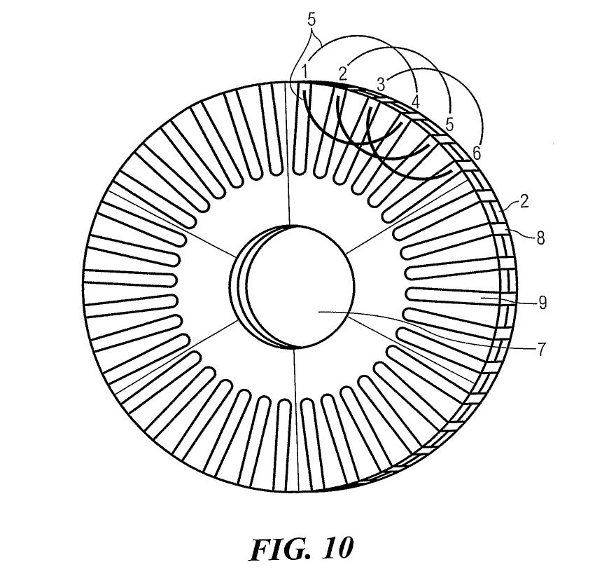

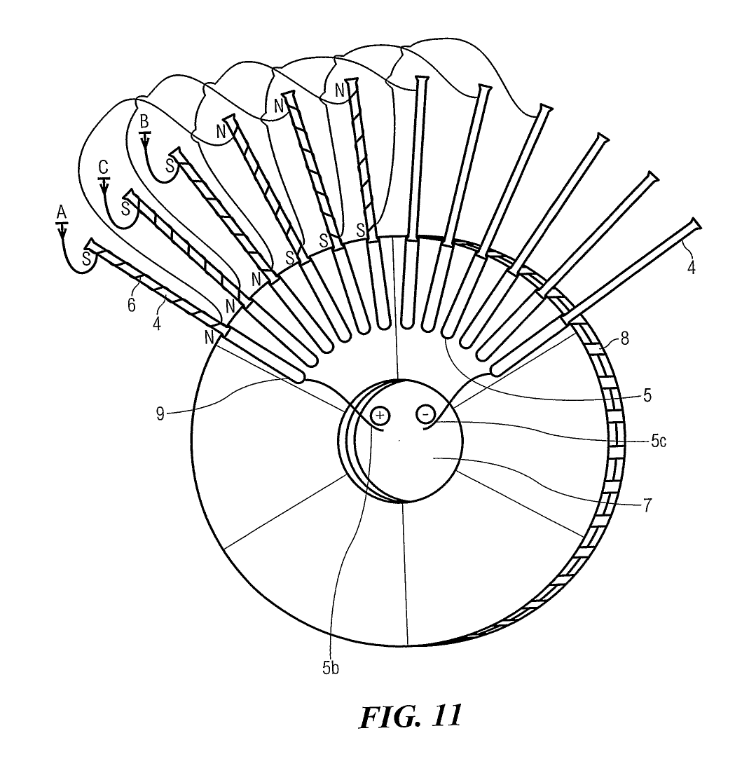

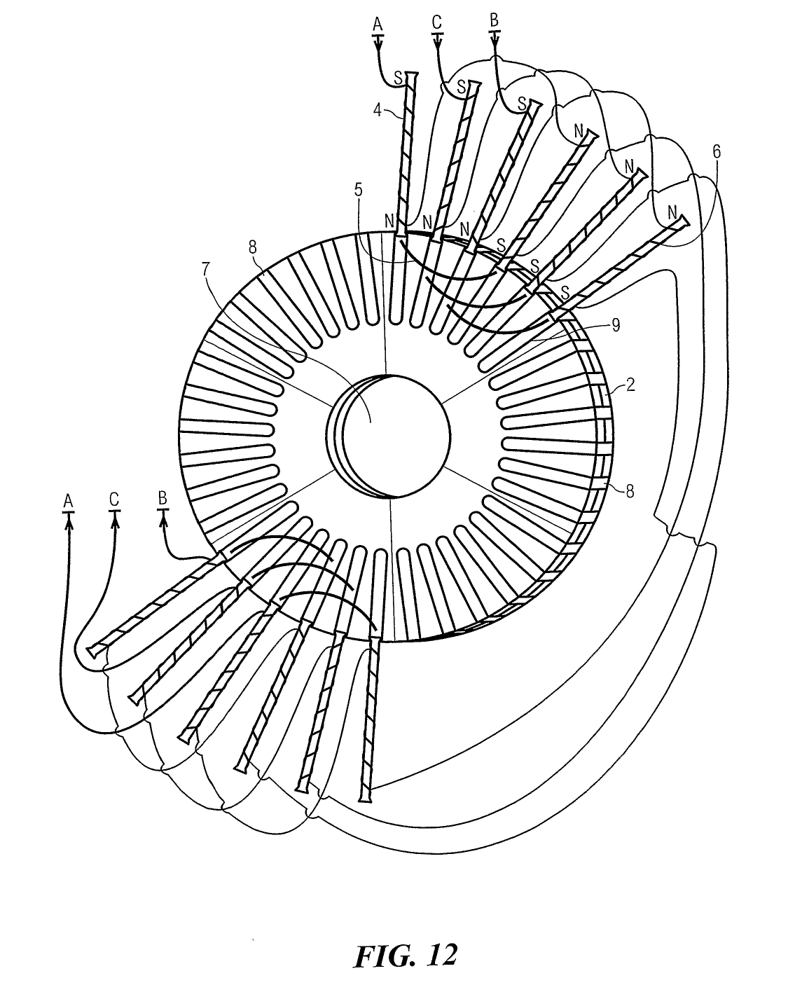

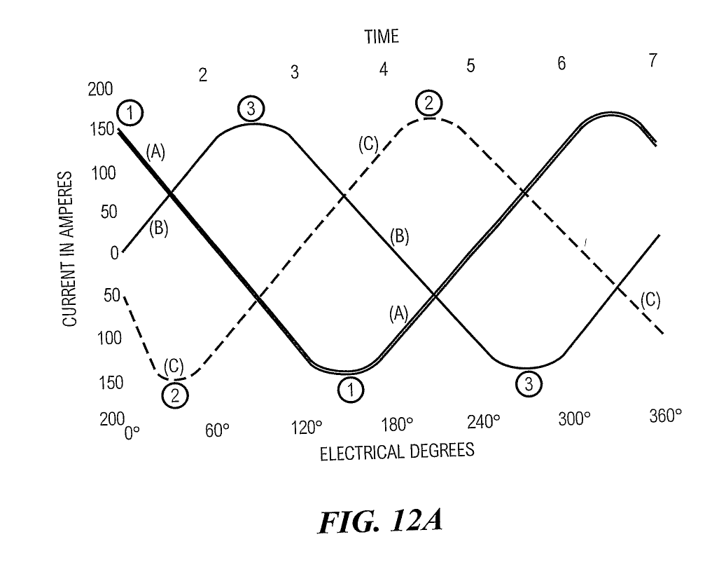

FIG. 7 is a representation of an end view of the laminated steel stator core used in the second embodiment of the invention. In this embodiment, the induction coil slots are placed on the outer perimeter of the core rather than on the inner surface of the core. The wire slots 9 are cut into the outer surface of the core 8. FIG. 8 is a representation of a lateral view of the laminated steel stator core of FIG. 7. The laminated steel core 8 reveals the laminations 2 and power induction coil slots 9. FIG. 9 is a representation of the embodiment from FIGS. 7 and 8 which contains the generating pole iron 4 of an embodiment of the invention. The laminated steel core 8 contains coil slots 9 which are cut into the laminate 2. The pole iron 4 is ultimately slid in on top of the slot wedges which cover the induction coils so that the magnetic fields are delivered in as close proximity to the induction coils as possible. FIG. 10 is a representation of the wound induction coils of a single phase cogeneration unit. The induction coil group 5 contains three coils which are laid into the insulated slots. Coil #1 is laid into slot 1 and slot 4, Coil #2 is laid into slots 2 and 5. Coil #3 is laid into slots 3 and 6. FIG. 11 is a representation of the wound coils of single phase induction coils along with the wound coils of the generating poles of the embodiment depicted in FIGS. 6, 7, 8, 9 and 10. The sequencing of the power generating poles is as described in FIG. 6. This FIG. 11 reveals pole iron 4 which has been wound with copper magnet wire to form the electromagnetic pole 6. The poles 6 have been slid into the slot over the slot wedges in each induction coil slot of the device, a portion of which are depicted in FIG. 11. The pole windings are simple conduits for the three phase legs of the three phase power as described in FIG. 6. The three induction coils in each of the six groups are connected in series forming the neutral 5b and the hot wire 5c of the generated power. FIG. 12 is a representation of the wiring schematics for generation of three phase power by the cogeneration unit of an embodiment of the current invention. The three phases are separated by 60° retardation of voltage and current fed to three separate groups of pole magnets 6 for each positive and each negative phase of the 360° cycle. Therefore the manipulation of the leads of the three phase input allows retardation of the generating current. As can be seen from FIG. 12a when the current in Phase A is at a maximum positive current flow, the current in Phase C reaches a maximum negative current flow 60° later and Phase B reaches a maximum positive current flow 60° following Phase C. This phenomenon allows a manipulation of the lead sequencing and reversal of the pole winding on the second pole of each group of the three poles such that the poles activate in sequence around the circumference of the stator just as a rotor in a standard generator. This phenomenon allows a manipulation of the lead sequencing in an embodiment of the current invention to allow the generation of three phase power in the present solid state invention. Phase A is generated by feeding current from incoming power to the first pole coil of the first phase coil grouping (FIG. 12.) This first pole is wound such that a north pole is generated on the end which is in the induction coil slot 9. The end of this pole cod magnet wire of the #1 pole is then connected to pole coil #4 (FIG. 12) such that a south pole is generated on the end which is in the induction coil slot 9. The end of this pole coil #4 is then connected to pole coil #1 in the next phase 1 coil group (FIG. 12). This coil #1 is again wound in such a fashion as to generate north pole energy in the induction coil slot. The end of this pole coil #1 is then again connected to pole coil #4 of the coil group such that as a south pole is generated on the end which is in the induction coil slot 9. After the incoming phase 1 lead is energized the magnetic poles 1 and 4 of all the phase 1groups of pole coils it continues into the transmission to neutral or of a “WYE” connection of a three phase electric generator or three phase electric motor or other appliance. The remaining pole coils of generated phase 1 are wired in the same fashion with an incoming power phase sequence in the following order phase A-C-B, Generated phase 2 leg is fed in order with incoming phase power sequence to the pole coils in the following order, Phase C-B-A. This sequence retards the generated phase 2 leg by 120°. Generated phase 3 leg is fed in order with incoming three phase power sequence to the pole coils in the following order. Phase B-A-C. This sequence retards the generated phase 3 leg by 120° following the Phase 2 generated leg.

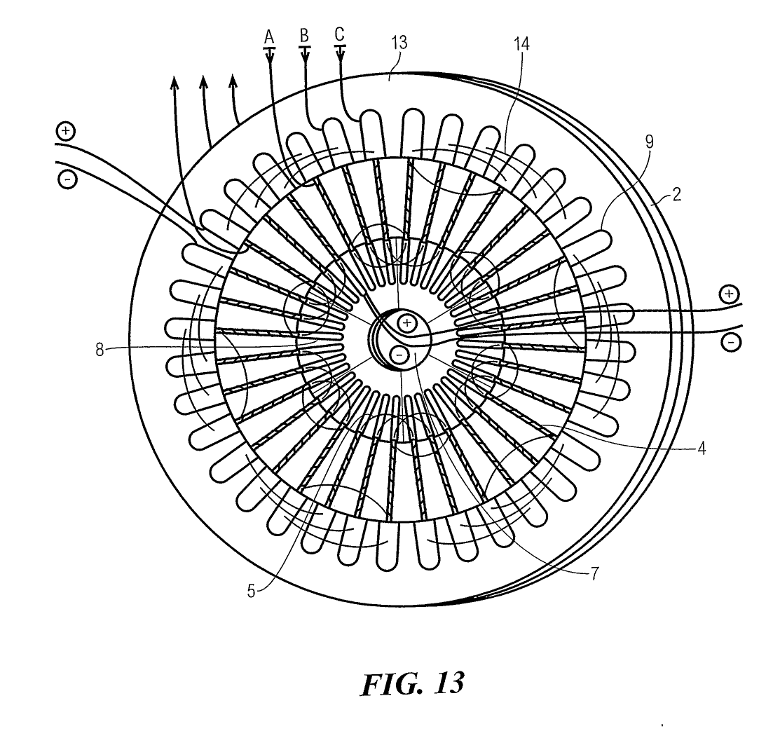

FIG. 13 is a representation of a single phase power cogeneration unit in which the energy generated by the pole coils is collected from both the north pole and south pole energy, so that the electric power generated is more than doubled in comparison to units which capture the energy from only one pole. The device in FIG. 13 is identical to the device in FIG. 11 except there is a second laminated iron core 13 in which the pole iron 4 contained in the slots of laminated core 8 fit into the induction coil slots of 13. Core 8 and core 13 are in a single plane and are the same thickness. The inner circumference of core 13 is such that the induction coil slots align with the induction slots of 8 such that the inner circumference of 13 and the outer circumference of 8 are sufficient to allow pole iron 4 to slide into the slots of both with a sufficient working tolerance. In order to deliver north pole sequence into the induction coil slots in 13 in the superior slot coils, the laminated core 13 rotated counter clockwise by three slots in reference to laminated core 8. The function of the inner cogeneration unit (laminated core 8) is the same as that described in FIG. 11. The outer cogeneration unit functions in the same manner. The generated electricity is collected on induction coils five (5) and fourteen (14), which are connected to appropriate loads.

This cogeneration technology can by used in any application where alternating current or pulsed direct current is flowing on a neutral or to ground including the neutral of a rotary three phase generator. Examples are power generation plants, substations, homes, plant, business, and electric motive devices, to name only a few. When this device is used in conjunction with super conductor coils applied to the pole generation coils, unlimited amounts of power can be generated without additional use of fossil fuels. Immersion of the entire unit in liquid nitrogen will give a super conductor effect. The power (current flow) needed to activate the cogeneration coils can be provided by solar, hydroelectric, geothermal and wind power as well as fossil fuel sources.

Test Findings From The Second Embodiment of the Current Invention

The second embodiment of the current invention was set up with watt/amp meters at appropriate locations to monitor current, voltage and wattage. The 3 phase poles were supplied by three phase lines from commercial 3 phase current connected to the load cells (see Table #1).

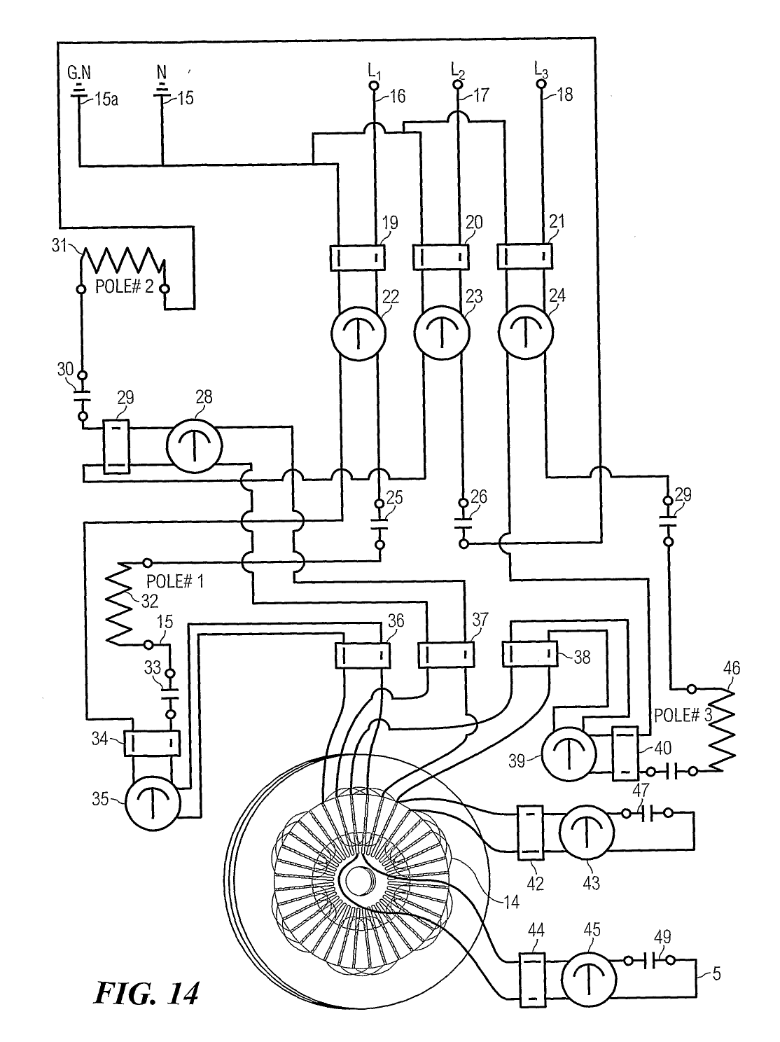

FIG. 14 is a diagrammatic representation of the test conduit used to test the second generation prototype. The data is summarized in table #1 and represents the average of three stable readings taken over two minutes. The reference numerals which denote the location of the readings in FIG. 14 are in parenthesis following the summary data point. This test cell which includes an embodiment of the current invention is powered by a 3 phase commercial power source with a ground neutral. The ground neutral 15 is the equivalent of a “WYE” connection in a three phase generator or a three phase electric motor or other appliance which makes up with L-1, 16 into plug 19. Watt/amp meter 22 plugs into 19. The power leg 16 then goes directly through a single pole, single throw breaker 25 to the feed side of static load 32. The current then enters ground neutral 15 and traverses through a single pole, single throw breaker 33 through plug 34 and watt/amp meter 35 onto plug 36 and connects with pole 1 of the induction coil group #1. The winding is wound in a north pole direction looking down from the top toward slot 9 of the center core of laminated steel. The lead then exits from pole #1 and makes up with pole #4 of the group of six poles contained in the first coil group. The exit lead from pole #4 then makes up with pole #1 in the second coil group and continues in this fashion until the current exits from pole #4 of the sixth coil group and makes up in plug 36. The current then flows through meter 35, to plug 34 onto meter 22 onto plug box 19 and to ground neutral 15 of the system. Phase C feeds pole #2 in the same manner and Phase B feeds pole #3.

Induction field coils 14 were wound with small wire of insufficient size and too many turns to generate sufficient current flow. The unit as it currently exits puts out about 5-10 percent of the ground neutral current passing through it with induction field coils 5 and 14 maximized as well as maximizing all other parameters, it is estimated that this unit will generate 15-20 percent of the ground neutral current flowing through it. This current amounts to available electric power which is currently not being used.

While embodiments of the invention have been described and illustrated, it will be understood by those skilled in the technology concerned that many variations or modifications in details of design or construction may be made without departing from the present invention.

The specification refers to and is supported by the following tables:

TABLE 1

Ground Lead Electric Power Cogeneration Unit (EPU) #2

Introduction Pole Coil Hookup

I. Phase leg #1 load neutral connection to pole coil #1 which is north pole wound in reference to the slot of the inner generation induction coil field. A jumper is then connected from pole coil #1 to pole coil #4 which is wound in the opposite direction to pole coil #1. Phase leg #2 load neutral is connected to pole coil #2 which is wound in the opposite direction to pole coil #1. A jumper is then connected from pole coil #2 to pole coil #5 which is wound in the opposite direction to pole coil #4. Phase leg #3 load neutral is connected to pole coil #3 which is wound identical to pole #1. A jumper is then connected to pole coil #6 of this 3 coil group which is wound identical to pole coil #4.

A) System power generated is connected to a load.
a) Inner coil load (50)—2 (two) 60 watt light bulbs
b) Outer coil load (48)—one 60 watt light bulb.

1) Current flow and voltage

| | | |
|---|---|---|
| Phase leg | Amps | Volts |

a) From power supply into load cells

| | | |
|---|---|---|
| #1 (22) | 9.36 | 122.7 |
| #2 (23) | 7.29 | 122.8 |
| #3 (24) | 10.18 | 123.7 |

b) Exit from load cells

| | | |
|---|---|---|
| #1 (35) | 9.36 | 95.3 |
| #2 (28) | 7.31 | 106.9 |
| #3 (39) | 10.11 | 106.0 |

c) Into EPU

| | | |
|---|---|---|
| #1 (36) | 9.27 | 95.1 |
| #2 (37) | 7.26 | 106.9 |
| #3 (38) | 10.13 | 106.0 |

d) Out of EPU-split neutral to 1) Utility neutral 2) Ground neutral

| | | | |
|---|---|---|---|
| | 1) Utility | 2) Ground | |
| | neutral | neutral | |
| #1 (15) (15a) | 2.80 | 6.58 | 0.1 |
| #2 (15) (15a) | 2.34 | 5.09 | 0.1 |
| #3 (15) (15a) | 3.09 | 7.13 | 0.1 |

Power Generated - Load On

| Phase legs On | Inner Coil (50) | Outer Coil (48) |
|---|---|---|
| #1 + #2 + #3 | 1) amps 0.40 volts 84.4 | amps 0.39 volts 15* |
| | watts 34 | watts 51.0 |
| | 2) amps 0.44 volts 84.4 | |
| | watts 37.1 | |
| #1 + #2 | 1) amps 0.40 volts 76 | amps 0.17 volts 37 |
| | watts 34 | watts 604 |
| #1 | 1) amps 0.35 volts 70 | amps 0.17 volts 35 |
| | watts 24.5 | watts 6.1 |
| #2 | 1) amps 0.00 volts 0.30 | amps 0.00 volts 0.0 |
| | watts 0.00 | watts 0.00 |
| #2 + #3 | 1) amps 0.30 volts 52.9 | amps 0.14 volts 33 |
| | watts 15.9 | watts 5.34 |
| #3 | 1) amps 0.31 volts 54.4 | amps 0.16 volts 33 |
| | watts 16.9 | watts 5.31 |
| #1 + #3 | 1) amps 0.40 volts 82.3 | amps 0.37 volts 15 |
| | watts 33 | watts 58.46 |
| | 1) amps 0.43 volts 82.34 | |
| | watts 35.4 | |

Generated Coil Voltage - Without load

| Phases On | Voltage Inner Coil | Voltage Outer Coil |
|---|---|---|
| #1 + #2 + #3 | 345 | >600 |
| #1 + #2 | 218.4 | 520 |
| #1 | 207.8 | 509 |
| #2 | 9.5 | 9.7 |
| #2 + #3 | 185.1 | 490 |
| #3 | 193.9 | 493 |
| #1 + #3 | 345.4 | >600 |

II. Same phase pole connection as on #1 above but with no bad applied to the generated power coils

1) Current flow and voltage

| | | |
|---|---|---|
| Phase leg | Amps | Volts |

a) From power supply into load cells

| | | |
|---|---|---|
| #1 (22) | 6.98 | 122.8 |
| #2 (23) | 7.29 | 123.3 |
| #3 (24) | 7.15 | 122.9 |

b) Exit from load cells (neutral)

| | | |
|---|---|---|
| #1 (35) | 6.94 | 107.4 |
| #2 (28) | 7.26 | 107.1 |
| #3 (39) | 7.13 | 106.5 |

c) Onto EPU (neutral)

| | | |
|---|---|---|
| #1 (36) | 6.98 | 107.3 |
| #2 (37) | 7.25 | 106.9 |
| #3 (38) | 7.13 | 106.2 |

d) Out of EPU (split neutral—utility neutral and Ground neutral)

| | | | |
|---|---|---|---|
| | 1) Utility neutral | 2) Ground neutral | |
| #1 (15) (15a) | 2.18 | 4.88 | 0.00 |
| #2 (15) (15a) | 2.35 | 5.01 | 0.00 |
| #3 (15) (15a) | 2.26 | 4.97 | 0.00 |

III. Same phase, pole coil hook up as #I right phase leg #1 switched to pole #3 and phase leg #3 is switched to pole #1.

A) Generated power connected to load (inner coil load 60 watts bulbs×2, outer coil one 60 watt bulb)

1) Current flow and voltage

| | | |
|---|---|---|
| Phase leg | Amps | Volts |

a) From 3 phase power supply into load cells

| | | |
|---|---|---|
| #1 (22) | 8.95 | 121.9 |
| #2 (23) | 7.22 | 121.8 |
| #3 (24) | 9.83 | 122.4 |

b) Exit from load cells (neutral)

| | | |
|---|---|---|
| #1 (35) | 8.92 | 95.0 |
| #2 (28) | 7.18 | 106.1 |
| #3 (39) | 9.87 | 103.4 |

c) Into EPU (neutral)

| | | |
|---|---|---|
| #1 (36) | 8.93 | 94.9 |
| #2 (37) | 7.13 | 106.0 |
| #3 (38) | 10.01 | 103.3 |

d) Out of EPU (split neutral to utility neutral and Ground neutral)

| | | | |
|---|---|---|---|
| | 1) Utility | 2) Ground | |
| | neutral | neutral | |
| #1 (15) (15a) | 2.38 | 6.51 | 0.00 |
| #2 (15) (15a) | 2.25 | 5.11 | 0.00 |
| #3 (15) (15a) | 2.73 | 7.33 | 0.00 |

Power Generated - Load On
(Inner coil load - 2 (two) 60 watt light bulbs,
Outer coil load - one 60 watt bulb)

| Phase legs On | Inner Coil group | Outer Coil group |
|---|---|---|
| #1 + #2 + #3 | 1) amps 0.5 volts 86.1 | amps 0.39 volts 159 |
| | watts 43.05 | watts 58.9 |
| | 2) amps 0.5 volts 86 | |
| | watts 43.05 | |
| #1 + #2 | 1) amps 0.17 volts 16.1 | amps 0.16 volts 32.8 |
| | watts 2.74 | watts 5.25 |
| | 2) amps 0.17 volts 16.1 | |
| | watts 2.74 | |
| #1 | 1) amps 0.17 volts 15.4 | amps 0.16 volts 37 |
| | watts 2.62 | watts 5.05 |
| | 2) amps 0.17 volts 15.4 | |
| | watts 2.62 | |
| #2 | 1) amps 0.00 volts 0.00 | amps 0.00 volts 0.00 |
| | watts 0.00 | watts 0.00 |
| | 2) amps 0.00 volts 0.00 | |
| | watts 0.00 | |
| #2 + #3 | 1) amps 0.20 volts 24.4 | amps 0.17 volts 35 |
| | watts 4.88 | watts 6.07 |
| | 2) amps 0.22 volts 24.4 | |
| | watts 5.37 | |
| #3 | 1) amps 0.19 volts 22.3 | amps 0.16 volts 34.8 |
| | watts 4.24 | watts 5.37 |
| | 2) amps 2.1 volts 22.3 | |
| | watts 4.68 | |
| #1 + #3 | 1) amps 0.40 volts 84.8 | amps 0.37 volts 159.3 |
| | watts 33.52 | watts 58.9 |
| | 2) amps 0.44 volts 84.8 | |
| | watts 37.31 | |

Voltage Without load

| Phases On | Voltage Inner Coil | Voltage Outer Coil |
|---|---|---|
| #1 + #2 + #3 | 346.5 | >600 |
| #1 + #2 | 192.5 | 478 |
| #1 | 193.1 | 471 |
| #2 | 7.5 | 6.8 |
| #2 + #3 | 212.5 | 486 |
| #3 | 206.6 | 482 |
| #1 + #3 | 340 | >600 |

IV. Hook up same as in I above right phase leg #1 on pole #3 phase leg #2 is on pole #1 and phase leg #3 is on pole #2.

A) Generated power connected to load (inner coil load 60 watts bulbs×2, outer coil cone 60 watt bulb)

1) Current flow and voltage

| | | |
|---|---|---|
| Phase leg | Amps | Volts |

a) From power supply into load cells

| | | |
|---|---|---|
| #1 (22) | 9.87 | 122.1 |
| #2 (23) | 9.08 | 122.5 |
| #3 (24) | 7.26 | 122.5 |

b) Exit from load cells

| | | |
|---|---|---|
| #1 (35) | 9.85 | 103.8 |
| #2 (28) | 9.08 | 95.3 |
| #3 (39) | 7.27 | 106.2 |

c) Into EPU

| | | |
|---|---|---|
| #1 (36) | 9.85 | 103.0 |
| #2 (37) | 9.08 | 95.0 |
| #3 (38) | 7.24 | 105.8 |

d) Out of EPU - (split neutral, 1) Utility neutral, 2) Ground neutral

| | | | |
|---|---|---|---|
| | Neutral | Ground neutral | |
| #1 (15) (15a) | 2.84 | 7.10 | 0.00 |
| #2 (15) (15a) | 2.57 | 6.61 | 0.00 |
| #3 (15) (15a) | 2.33 | 5.05 | 0.00 |

Power Generated - Load On
(Inner coil load - 2 (two) 60 watt light bulbs,
outer coil load - one 60 watt bulb)

| Phase legs On | Inner Coil group | Outer Coil group |
|---|---|---|
| #1 + #2 + #3 | 1) amps 0.4 volts 84.8 | amps 0.37 volts 15 |
| | watts 34 | watts 59.1 |
| | 2) amps 0.43 volts 84.8 | |
| | watts 36.5 | |
| #1 + #2 | 1) amps 0.39 volts 81.9 | amps 0.37 volts 158 |
| | watts 32 | watts 58.46 |
| | 2) amps 0.43 volts 81.9 | |
| | watts 35.2 | |
| #1 | 1) amps 0.17 volts 15.7 | amps 0.16 volts 31.1 |
| | watts 2.7 | watts 5.0 |
| | 2) amps 0.17 volts 15.7 | |
| | watts 2.7 | |
| #2 | 1) amps 0.19 volts 21.9 | amps 0.16 volts 3 |
| | watts 4.16 | watts 5.55 |
| | 2) amps 0.21 volts 21.9 | |
| | watts 4.6 | |
| #2 + #3 | 1) amps 0.20 volts 24.5 | amps 0.17 volts 37.8 |
| | watts 4.9 | watts 4.43 |
| | 2) amps 0.22 volts 24.5 | |
| | watts 5.4 | |
| #3 | 1) amps 0.00 volts 0.00 | amps 0.00 volts 0.00 |
| | watts 0.00 | watts 0.00 |
| | 2) amps 0.00 volts 0.00 | |
| | watts 0.00 | |
| #1 + #3 | 1) amps 0.16 volts 15.0 | amps 0.15 volts 31.6 |
| | watts 2.40 | watts 4.74 |
| | 2) amps 0.17 volts 15 | |
| | watts 2.55 | |

Generation coil voltage without load

| Phases Legs On | Voltage Inner Coil | Voltage Outer Coil |
|---|---|---|
| #1 + #2 + #3 | 349.0 | >606 |
| #1 + #2 | 348.7 | >600 |
| #1 | 194.7 | 470 |
| #2 | 208.5 | 487 |
| #2 + #3 | 219.0 | 498 |
| #3 | 9.1 | 11.0 |
| #1 + #3 | 185.5 | 465 |

V. Hook up same as I except phase leg #1 on pole #1, phase leg #2 is on pole #3, phase leg #3 one pole #2.
a) Generated power on to load (inner coil load 60 watt light bulb×2, out coil load 60 watts bulb)

b 1) Current flow and voltage

| | | |
|---|---|---|
| Phase leg | Amps | Volts |

a) From power supply into load cells

| | | |
|---|---|---|
| #1 (22) | 9.92 | 122.5 |
| #2 (23) | 9.05 | 123.2 |
| #3 (24) | 7.29 | 122.3 |

b) Exit from load cells (neutral)

| | | |
|---|---|---|
| #1 (35) | 9.89 | 103.2 |
| #2 (28) | 9.04 | 95.8 |
| #3 (39) | 7.26 | 106.6 |

c) Into EPU (neutral)

| | | |
|---|---|---|
| #1 (36) | 10.01 | 103.5 |
| #2 (37) | 9.02 | 96.1 |
| #3 (38) | 7.28 | 106.5 |

d) Out of EPU (split neutral, 1) utility neutral 2) Ground neutral)

| | Amps | | |
|---|---|---|---|
| Phase leg | Neutral | Ground neutral | Volts |
| #1 (15) (15a) | 2.57 | 7.52 | 0.00 |
| #2 (15) (15a) | 2.35 | 6.73 | 0.00 |
| #3 (15) (15a) | 2.13 | 5.22 | 0.00 |

Power Generated - Load On
(Inner coil load - 2 (two) 60 watt light bulbs,
outer coil load - one 60 watt bulb)

| Phase leg on | Inner coil group | Outer coil group |
|---|---|---|
| #1 + #2 + #3 | 1) amps 0.41 volts 86.3 | amps 0.37 volts 160 |
| | watts 35.38 | watts 59.5 |
| | 2) amps 0.43 volts 86.3 | |
| | watts 37.11 | |
| #1 + #2 | 1) amps 0.40 volts 84.5 | amps 0.37 |
| | watts 33.8 | volts 159.8 watts 59.13 |
| | 2) amps 0.43 volts 84.2 | |
| | watts 36.21 | |
| #1 | 1) amps 0.19 volts 21.7 | amps 0.16 volts 34.5 |
| | watts 4.12 | watts 5.52 |
| | 2) amps 0.20 volts 21.7 | |
| | watts 4.34 | |
| #2 + #3 | 1) amps 0.17 volts 16.5 | amps 0.16 volts 33.1 |
| | watts 2.86 | watts 5.30 |
| | 2) amps 0.18 volts 16.5 | |
| | Watts 2.97 | |
| #3 | 1) amps 0.00 volts 0.00 | amps 0.00 volts 0.00 |
| | watts 0.00 | watts 0.00 |
| | 2) amps 0.00 volts 0.00 | |
| | watts 0.00 | |
| #1 + #3 | 1) amps 0.20 volts 23.6 | amps 0.17 volts 33. |
| | watts 4.72 | watts 6.09 |
| | 2) amps 0.22 volts 23.6 | |
| | watts 5.19 | |

Generation coil voltage Without load

| Phases On | Voltage Inner Coil | Voltage Outer Coil |
|---|---|---|
| #1 + #2 + #3 | 350.7 | >600 |
| #1 + #2 | 344.7 | >600 |
| #1 | 207.8 | 486 |
| #2 | 195.6 | 472 |
| #2 + #3 | 195.5 | 476 |
| #3 | 7.3 | 8.9 |
| #1 + #3 | 213.0 | 488 |

VI. Single phase hook up, same as I
Evaluation of utility neutral Line vs. ground neutral
   a) Generated power on to load (inner coil load 60 watt light bulb×2, outer coil load 60 watt light bulb)

Power company neutral is connected—

Ground neutral is disconnected

| | | |
|---|---|---|
| Phase leg | Amps | Volts |

a) From power supply into load cells

| | | |
|---|---|---|
| #1 (22) | 9.09 | 123.3 |
| #2 (23) | 7.26 | 123.1 |
| #3 (24) | 9.88 | 122.6 |

b) Exit from load cells (neutral)

| | | |
|---|---|---|
| #1 (35) | 9.07 | 95.9 |
| #2 (28) | 7.26 | 106.5 |
| #3 (39) | 9.83 | 103.8 |

c) Into EPU (neutral)

| | | |
|---|---|---|
| #1 (36) | 9.61 | 96 |
| #2 (37) | 7.30 | 100.1 |
| #3 (38) | 9.82 | 103.0 |

d) Out of EPU - Utility neutral

| | | |
|---|---|---|
| #1 (15) | 9.04 | 1.30 |
| #2 (15) | 7.25 | 1.50 |
| #3 (15) | 9.89 | 1.30 |

Power Generated - Load On
(Inner coil load - 2 (two) 60 watt light bulbs,
outer coil load - one 60 watt bulb)

| Phase legs On | Inner Coil group | Outer Coil group |
|---|---|---|
| #1 + #2 + #3 | 1) amps 0.40 volts 84.1 | amps 0.32 volts 157.9 |
| | watts 33.64 | watts 58.42 |
| | 2) amps 0.43 volts 84.1 | |
| | watts 36.16 | |
| #1 + #2 | 1) amps 0.21 volts 24.8 | amps 0.17 volts 38.2 |
| | watts 5.21 | watts 6.49 |
| | 2) amps 0.22 volts 24.8 | |
| | watts 5.36 | |
| #1 | 1) amps 0.20 volts 22.7 | amps 0.17 volts 35 |
| | watts 4.54 | watts 6.03 |
| | 2) amps 0.21 volts 22.7 | |
| | watts 4.77 | |
| #2 | 1) amps 0.00 volts 0.00 | amps 0.00 volts 0.00 |
| | watts 0.00 | watts 0.00 |
| | 2) amps 0.00 volts 0.00 | |
| | watts 0.00 | |
| #2 + #3 | 1) amps 0.16 volts 15.6 | amps 0.16 volts 32 |
| | watts 2.50 | watts 5.15 |
| | 2) amps 0.17 volts 15.6 | |
| | watts 2.65 | |
| #3 | 1) amps 0.17 volts 16.0 | amps 0.16 volts 32 |
| | watts 2.72 | watts 5.15 |
| | 2) amps 0.18 volts 16.0 | |
| | watts 2.88 | |
| #1 + #3 | 1) amps 0.39 volts 84.3 | amps 0.37 volts 16.1 |
| | watts 32.88 | watts 59.61 |
| | 2) amps 0.44 volts 84.3 | |
| | watts 37.09 | |

Generation coil voltage without load

| Phases On | Voltage Inner Coil | Voltage Outer Coil |
|---|---|---|
| #1 + #2 + #3 | 348 | >600 |
| #1 + #2 | 218.2 | 497 |
| #1 | 207.9 | 485 |
| #2 | 8.8 | 10.7 |
| #2 + #3 | 184.7 | 462 |
| #3 | 193.2 | 468 |
| #1 + #3 | 347.4 | >600 |

B) Generated power on to load (inner coil load 60 watt light bulb×2, outer coil load 60 watt light bulb) ground neutral connected to utility neutral disconnected.

| | | |
|---|---|---|
| Phase leg | Amps | Volts |

a) From power supply into load cells

| | | |
|---|---|---|
| #1 (22) | 9.12 | 124.2 |
| #2 (23) | 7.21 | 124.8 |
| #3 (24) | 9.93 | 124.2 |

b) Exit from load cells (neutral)

| | | |
|---|---|---|
| #1 (35) | 9.12 | 97.5 |
| #2 (28) | 7.20 | 109.2 |
| #3 (39) | 9.90 | 104.8 |

c) Into EPU (neutral)

| | | |
|---|---|---|
| #1 (36) | 9.04 | 97.5 |
| #2 (37) | 7.25 | 109.2 |
| #3 (38) | 9.85 | 104.9 |

d) Out of EPU - Ground neutral (Probably neutral ***)

| | | |
|---|---|---|
| #1 (15a) | 9.10 | 25.4 |
| #2 (15a) | 7.21 | 25.4 |
| #3 (15a) | 9.98 | 25.4 |

Power Generated - Load On
(Inner coil load - 2 (two) 60 watt light bulbs,
outer coil load - one 60 watt bulb)

| Phase legs On | Inner Coil group | Outer Coil group |
|---|---|---|
| #1 + #2 + #3 | 1) amps 0.40 volts 87.1 | amps 0.37 volts 164.1 |
| | watts 34.84 | watts 60.72 |
| | 2) amps 0.44 volts 87.1 | |
| | watts 38.32 | |
| #1 + #3 | 1) amps 0.40 volts 86.1 | amps 0.37 volts 164.0 |
| | watts 34.44 | watts 60.68 |
| | 2) amps 0.44 volts 86.1 | |
| | watts 37.88 | |
| #1 | 1) amps 0.00 volts 0.6 | amps 0.00 volts 0.00 |
| | watts 0.00 | watts 0.6 |
| | 2) amps 0.00 volts 0.6 | |
| | watts 0.00 | |
| #2 | 1) amps 0.00 volts 0.00 | amps 0.00 volts 0.00 |
| | watts 0.00 | watts 0.00 |
| | 2) amps 0.00 volts 0.00 | |
| | watts 0.00 | |
| #2 + #3 | 1) amps 0.15 volts 12.1 | amps 0.14 volts 24 |
| | watts 1.82 | watts 3.46 |
| | 2) amps 0.16 volts 12.1 | |
| | watts 1.94 | |
| #3 | 1) amps 0.00 volts 0.4 | amps 0.00 volts 0.6 |
| | watts 0.00 | watts 3.51 |
| | 2) amps 0.00 volts 0.4 | |
| | watts 0.00 | |
| #1 + #2 | 1) amps 0.17 volts 18.1 | amps 0.14 volts 25 |
| | watts 3.08 | watts 3.51 |
| | 2) amps 0.19 volts 18.1 | |
| | watts 3.44 | |

Generation coil voltage without load

| Phases On | Voltage Inner Coil | Voltage Outer Coil |
|---|---|---|
| #1 + #2 + #3 | 353 | >600 |
| #1 + #2 | 186.4 | 426 |
| #1 | 33.4 | 76 |
| #2 | 1.7 | 0.7 |
| #2 + #3 | 170 | 421 |
| #3 | 28.1 | 72.4 |
| #1 + #3 | 351.7 | >600 |

Phase lead current flow—by passing EPU (cogeneration unit)—neutral from load is wired directly to power company neutral—wired for single phase load [load a Test artificial load] in a triple 4.2 ohms resistance load cell.

| Phase Lead | load resistance ohms | amps | | |
|---|---|---|---|---|
| #1 | 4.2 ohms | 29.27 | 29.12 | 29.21 |
| #2 | 4.2 ohms | 29.13 | 28.03 | 29.06 |
| #3 | 4.2 ohms | 29.17 | 29.05 | 29.24 |

| Phase | Resistance from coil neutral power company |
|---|---|
| Lead | neutral through 15 ft of #10 copper conduit |
| #1 | 0.1 ohms |
| #2 | 0.1 ohms |
| #3 | 0.1 ohms |

VIII. Cogeneration hook up with each phase leg energizing 2 groups of pole irons.

Pole Group #1

Phase #1 is connected to pole #1 wound counter clockwise→jumper to pole #4 wound clockwise jumper back to pole #3 wound counter clockwise→jumper to pole #6 wound clockwise [load a test artificial load] is a triple 4.2 ohm resistive load cell.

Pole Group #2

A jumper from pole #6 of pole group #1 is connected to pole #1 of pole group #2 which is wound counter clockwise→→→a jumper from pole #1 is connected to pole #4 which is wound counter clockwise→a jumper is connected from pole #4 to pole #6 which is wound clockwise. The end of pole #6 is then attached to a common neutral.

Phase #2 is wired in the same fashion to pole group #3 and #4.

Phase #3 is wired in the same fashion to pole group #5 and #6.

Resistance in pole groups

#1 and #2—0.6 ohms

#3 and #4—0.6 ohms

#5 and #6—0.6 ohms

Resistance in circuit (absent cogeneration unit) i.e. hot wire, ground neutral and load [load a test artificial load].

Phase #1—4.3 ohms

Phase #2—4.3 ohms

Phase #3—4.3 ohms

Resistance in entire circuit including cogeneration unit

Phase #1—4.8 ohms

Phase #2—4.8 ohms

Phase #3—5.2 ohms

Ground neutral and power company neutral are both engaged.

Current flow into all 3 load cells is separate but simultaneous [load a test artificial load]

Current flows into load cells (coils)

| Phase leg | Amps | Volts |
|---|---|---|
| #1 (22) | 12.23 | 123.4 |
| #2 (23) | 12.15 | 124.5 |
| #3 (24) | 12.71 | 124.3 |

Current flow out of load cells

| Phase leg | Amps | Volts |
|---|---|---|
| #1 (35) | 12.34 | 93.6 |
| #2 (28) | 12.19 | 94.6 |
| #3 (39) | 12.60 | 93.1 |

Current flow into EPU

| Phase leg | Amps | Volts |
|---|---|---|
| #1 (36) | 12.31 | 93.4 |
| #2 (37) | 12.14 | 94.1 |
| #3 (38) | 12.78 | 92.7 |

Current flow out of EPU

| | Amps | | |
|---|---|---|---|
| Phase leg | 1) neutral | 2) Ground neutral | Volts |
| #1 (15) (15a) | 3.15 | 9.67 | 0.3 |
| #2 (15) (15a) | 3.60 | 9.52 | 0.3 |
| #3 (15) (15a) | 3.85 | 9.62 | 0.3 |

Power Generated/Load On

| Phase legs On | Inner Coil group | Outer Coil group |
|---|---|---|
| #1 + #2 + #3 | 1) amps 0.00 volts 0.00 | amps 0.00 volts 0.00 |
| | watts 0.00 | watts 0.6 |
| | 2) amps 0.00 volts 0.00 | |
| | watts 0.00 | |
| #1 + #2 | 1) amps 0.00 volts 0.00 | amps 0.00 volts 0.00 |
| | watts 0.00 | watts 0.6 |
| | 2) amps 0.00 volts 0.00 | |
| | watts 0.00 | |
| #1 | 1) amps 0.00 volts 0.00 | amps 0.00 volts 0.00 |
| | watts 0.00 | watts 0.00 |
| | 2) amps 0.00 volts 0.00 | |
| | watts 0.00 | |
| #2 | 1) amps 0.00 volts 0.00 | amps 0.00 volts 0.00 |
| | watts 0.00 | watts 0.00 |
| #2 + #3 | 1) amps 0.00 volts 0.00 | amps 0.00 volts 0.00 |
| | watts 0.00 | watts 0.00 |
| | 2) amps 0.00 volts 0.00 | |
| | watts 0.00 | |
| #3 | 1) amps 0.00 volts 0.00 | amps 0.00 volts 0.00 |
| | watts 0.00 | watts 0.00 |
| | 2) amps 0.00 volts 0.00 | |
| | watts 0.00 | |
| #1 + #3 | 1) amps 0.00 volts 0.00 | amps 0.00 volts 0.00 |
| | watts 0.00 | watts 0.00 |
| | 2) amps 0.00 volts 0.00 | |
| | watts 0.00 | |

Frequency measured by single channel oscilloscope
1) Inner coil is mixed pulsating frequency mostly single cycle-mixed phases
2) Outer coil is oscillating 60 cycle waveform.

Voltage without load

| Phases On | Voltage Inner Coil | Voltage Outer Coil |
|---|---|---|
| #1 + #2 + #3 | 24.4 | 22.9 |
| #1 + #2 | 15.6 | 18.4 |
| #1 | 12.5 | 19.9 |
| #2 | 49 | 16.0 |
| #2 + #3 | 13.9 | 18.1 |
| #3 | 9.4 | 5.6 |
| #1 + #3 | 17.0 | 25.7 |

IX. Parallel Feed through Pole winding

EPU hook up fed by neutral from load cell [load a test artificial load] using sequential pole activation by 3 phase leads one pass through with pole coil with pole coil neutral connected in a modified “wye” i.e. all output from the pole iron coils are made up together then to the power company neutral and ground neutral. The remainder of the poles is wired in parallel by jumper wires, of #10 copper with and poles wound either counter clockwise (north pole) or clockwise (south pole).

Pole coil #2 in each group is not used because previous experiments indicated that it I had very little impact on power output

Resistance in single pole windings.

Phase #1—0.1 ohms

Phase #2—0.1 ohms

Phase #3—0.1 ohms

Resistance on entire circuit (using, load cells and EPU)

| | Ground neutral | Power companv neutral |
|---|---|---|
| Phase #1 | 4.30 | 4.30 |
| Phase #2 | 4.38 | 4.25 |
| Phase #3 | 4.30 | 4.25 |

Ground neutral and power company neutral (both engaged) current flow into all 3 load coils separate but simultaneous [load a test artificial load].

Current flow into load cells

| Phase Lead | AMPS | Volts |
|---|---|---|
| #1 (22) | 28.42 | 121.4 |
| #2 (23) | 28.46 | 122.1 |
| #3 (24) | 28.67 | 121.7 |

Current flow out of load cells—all 3 on

| Phase Lead | Amos | Volts |
|---|---|---|
| #1 (35) | 28.27 | 3.9 |
| #2 (28) | 28.28 | 5.0 |
| #3 (39) | 28.64 | 3.9 |

Current flow into EPU

| Phase Lead | Amps | Volts |
|---|---|---|
| #1 (36) | 28.16 | 3.6 |
| #2 (37) | 28.29 | 4.8 |
| #3 (38) | 28.39 | 3.8 |

Current flow out of EPU

| | Groups | | |
|---|---|---|---|
| Phase Lead | 1) Power neutral | 2) G neutral | Volts |
| #1 (15) (15a) | 0.82 | 0.94 | 0.60 |
| #2 (15) (15a) | 0.85 | 0.78 | 0.60 |
| #3 (15) (15a) | 0.87 | 0.35 | 0.60 |

Power Generated—Load On

| Phase lead On | | |
|---|---|---|
| #1 + #2 + #3 | 1) amps 0.11 volts 5.9 | amps 0.39 volts 9 |
| | watts 0.649 | watts 0.86 |
| | 2) amps 0.11 volts 5.9 | |
| | watts 0.649 | |
| #1 + #2 | 1) amps 0.06 volts 2.4 | amps 0.04 volts |
| | Watts 0.144 | watts 0.12 |
| | 2) amps 0.06 volts 2.4 | |
| | watts 0.144 | |
| #2 + #3 | 1) amps 0.05 volts 2.9 | amps 0.04 volts 2 |
| | watts 0.145 | watts 0.112 |
| | 2) amps 0.015 volts 2.9 | |
| | watts 0.145 | |
| #3 | 1) amps 0.05 volts 1.9 | amps 0.04 volts 3 |
| | watts 0.095 | watts 0.156 |
| | 2) amps 0.05 volts 1.5 | |
| | watts 0.095 | |
| #1 + #3 | 1) amps 0.11 volts 6.0 | amps 0.10 volts 10 |
| | watts 0.66 | watts 1.01 |
| | 2) amps 0.11 volts 6.0 | |
| | watts 0.66 | |

Voltage without load

| Phases Leads On | Voltage Inner Coil | Voltage Outer Coil |
|---|---|---|
| #1 + #2 + #3 | 135.1 | 319.2 |
| #1 + #2 | 76.9 | 183.4 |
| #1 | 75.3 | 177.6 |
| #2 | 3.2 | 1.3 |
| #2 + #3 | 67.9 | 170.1 |
| #3 | 65.1 | 169.4 |
| #1 + #3 | 13204 | 318.5 |

X. EPU hook up utilizing neutral from load cell [load a test artificial load]. Using sequential pole activation with 3 phase leads #1 and #3. Each phase lead is passed through two pole coils. A jumper is then fed from the phase lead to next set of pole coils (using only phase leads #1 and #3). Each phase lead activates 12 poles 6 groups of 2 poles in parallel. The neutral from the pole coils fed by phase lead #1 are made up to the utility neutral and the neutral from the pole coils fed by phase lead #3 are made up to the ground neutral.

Resistance in the 2 pole circuits

Phase #1

Pole pairs #1) 0.2 ohms #2) 0.2 ohms #3) 0.2 ohms #4) 0.2 ohms #5) 0.2 ohms #6) 0.2 ohms

Phase #3

Pole pairs #1) 0.2 ohms #2) 0.2 ohms #3) 0.2 ohms #4) 0.2 ohms #5) 0.2 ohms #6) 0.2 ohms

Resistance across [load a test artificial Load]. Each of three resistance coils.

#1) 4.2 ohms

#2) 4.2 ohms

#3) 4.2 ohms

Power flow into 2 load coils. Coils are separate but are activated simultaneously,

Current flow and voltage into load coils.

| Phase Lead | Amps | Volts |
|---|---|---|
| #1 (22) | 27.63 | 122.1 |
| #3 (24) | 1.38 | 124.3 |

Current flow and voltage out of lead coils.

| Phase Lead | Amps | Volts |
|---|---|---|
| #1 (35) | 27.4 | 10.7 |
| #3 (38) | 1.40 | 118.5 |

Current flow and voltage into EPU

| Phase Lead | Amps | Volts |
|---|---|---|
| #1 (36) | 27.18 | 10.5 |
| #3 (38) | 1.35 | 118.0 |

Current flow and voltage out of EPU

| Phase Lead | Amps | Volts |
|---|---|---|
| #1 (15) | 27.23 | 0.60 |
| #3 (15) | 1.32 | 120.2 |

Power Generated—Load On

| Phase lead On | | |
|---|---|---|
| #1 + #3 | 1) amps 0.13 volts 8.5 | 1) amps 0.10 volts 11 |
| | watts 1.11 | watts 1.10 |
| | 2) amps 0.13 volts 8.5 | |
| | watts 1.11 | |
| #1 | 1) amps 0.13 volts 8.2 | 1) amps 0.10 volts 10 |
| | Watts 1.07 | watts 1.05 |
| | 2) amps .13 volts 8.2 | |
| | watts 1.07 | |
| #3 | 1) amps 0.00 volts 0.00 | 1) amps 0.00 volts 0.00 |
| | watts 0.00 | watts 0.00 |
| | 2) amps 0.00 volts 0.00 | |
| | watts 0.00 | |

Voltage Without load

| Phases Leads On | Voltage Inner Coil | Voltage Outer Coil |
|---|---|---|
| #1 + #3 | 145.0 | 329.8 |
| #1 | 144.0 | 329 |
| #3 | 2.22 | 6.3 |

XI. EPU hook up utilizing neutral from load cell [load a test artificial load]. Using sequential pole activation with 3 phase leads #1 and #3. Each phase lead is passed through two pole coils. A jumper is then fed from the phase lead to the next set of pole coils (using only phase lead #1 and #3). Each phase lead activates 12 poles 6 groups of 2 poles in parallel. The neutral from the pole coils fed by phase lead #1 are made up to the ground neutral and the neutral from the pole coils fed by phase lead #3 are made up to the utility neutral.

Resistance in the 2 pole circuits

Phase #1

Pole pairs #1) 0.2 ohms #2) 0.2 ohms #3) 0.2 ohms #4) 0.2 ohms #5) 0.2 ohms #6) 0.2 ohms

Phase #3

Pole pairs #1) 0.2 ohms #2) 0.2 ohms #3) 0.2 ohms #4) 0.2 ohms #5) 0.2 ohms #6) 0.2 ohms

Current flow and voltage into 2 load cells which are separate but activated simultaneously.

Current flow and voltage into load cells.

| Phase Lead | Amps | Volts |
|---|---|---|
| #1 (22) | 1.26 | 123.8 |
| #3 (24) | 27.9 | 123.7 |

Current flow and voltage out of load.

| Phase Lead | Amps | Volts |
|---|---|---|
| #1 (35) | 1.28 | 118.6 |
| #3 (39) | 27.85 | 10.9 |

Current flow and voltage into EPU.

| Phase Lead | Amps | Volts |
|---|---|---|
| #1 (36) | 1.28 | 118.7 |
| #3 (34) | 27.71 | 10.7 |

Current flow and voltage out of EPU.

| Phase Lead | Amps | Volts |
|---|---|---|
| #1 (15) | 1.29 | 117.5 |
| #3 (15) | 27.76 | 0.4 |

Power generated—load on.

| Phase lead On | | |
|---|---|---|
| #1 + #3 | 1) amps 0.11 volts 6.3 | amps 0.10 volts 11 |
| | watts 0.69 | watts 1.1 |
| | 2) amps 0.11 volts 6.3 | |
| | watts 0.69 | |
| #1 | 1) amps 0.11 volts 5.6 | amps 0.09 volts 10.3 |
| | Watts 0.62 | watts 0.93 |
| | 2) amps .13 volts 8.2 | |
| | watts 1.07 | |
| #3 | 1) amps 0.00 volts 0.00 | |
| | watts 0.00 | |

Voltage without load

| Phases Leads On | Voltage Inner Coil | Voltage Outer Coil |
|---|---|---|
| #1 + #3 | 130.7 | 323.7 |
| #1 | 2.5 | 6.5 |
| #3 | 128.5 | 318.6 |

XII. EPU hook up same as immediately above except that 2 (two) #10 AWG jumpers are placed between ground neutral and utility neutral.

Current flow and voltage into load coils.

| Phase Lead | Amps | Volts |
|---|---|---|
| #1 (22) | 27.12 | 121.8 |
| #3 (24) | 28.23 | 123.3 |

Current flow and voltage out load coils.

| Phase Lead | Amps | Volts |
|---|---|---|
| #1 (35) | 27.12 | 9.8 |
| #3 (39) | 28.25 | 10.4 |

Current flow and voltage into EPU.

| Phase Lead | Amps | Volts |
|---|---|---|
| #1 (36) | 27.08 | 9.5 |
| #3 (34) | 28.21 | 10.3 |

Current flow and voltage out of EPU.

| Leads neutral + | | |
|---|---|---|
| G. neutral | Amps | Volts |
| #1 (15) | 11.41 | 0.4 |
| #3 (15) | 11.30 | 0.4 |

Power generated—load on.

| Phase lead On | | |
|---|---|---|
| #1 + #3 | 1) amps 0.20 volts 22.5 | amps 0.18 volts 40 |
| | Watts 4.5 | watts 7.25 |
| | 2) amps 0.22 volts 22.5 | |
| | Watts 4.95 | |
| #1 | 1) amps 0.13 volts 8.4 | amps 0.10 volts 10.4 |
| | Watts 1.09 | watts 1.04 |
| | 2) amps 0.13 volts 8.4 | |
| | watts 1.09 | |
| #3 | 1) amps 0.11 volts 5.7 | amps 0.09 volts 10.1 |
| | watts 0.627 | watts 0.91 |
| | 2) amps 0.11 volts 5.7 | |
| | watts 0.627 | |

Voltage Without load

| Phases Leads On | Voltage Inner Coil | Voltage Outer Coil |
|---|---|---|
| #1 + #3 | 2535 | 605 |
| #1 | 144.3 | 330.4 |
| #3 | 128.8 | 320.3 |

Cogeneration unit #2 EPU winding specification
1. Small inner collation coils (Induction)
   6 groups of coils/3 coils per group
   120 turns/coils of #18 copper magnet wire
2. Large outer induction coil group
   6 groups of coils/3 coils per group
   300 turns/coils of #18 copper magnet wire
3. Pole irons 4″×4″—60 turns of #10 copper magnet wire.

Table 1 Analysis

I. 3 poles with load on generated power

Power into EPU

#1 9.27×95.1=881.58 watts

#2 7.26×106.6=733.92 watts

#3 10.13×106.0=1073.78 watts

Total 2729.28

Power out of EPU

#1 9.38×0.1=0.938 watts

#2 7.43×0.1=0.743 watts

#3 10.22×0.1=1.022 watts

Power generated

#1+#2+#3 watts=122=4.5%

#1+#3 watts=126.86

$$\frac{126.86}{1955.36} = 6.5 \%$$

II. 3 poles—no load on generated power

Phase #1 to pole #1, phase #2 to pole 2, phase #3 to pole 32

Power into EPU

Phase Leg

#1 6.98×107.3=748.95 watts

#2 7.25×106.9=775.02 watts

#3 7.13×106.2=757.21 watts

Total 2281.18 watts

#1=15% less impedance if load is on

#2=no difference

#3=30% less impedance if load is on

III. 3 poles—switched phase leg #1 to pole #3 and phase leg #3 to pole #1

Power into EPU is same or slightly less

Into EPU

#1 847.5

#2 755.8

#9 1034.3

Power generated

#1+#2+#3 watts=145

$$\frac{145}{2630} = 5.5 \%$$

#1+#3 watts=130.1

$$\frac{130.1}{188.18} = 6.9 \%$$

IV. 3 poles phase #1 on pole #3, phase #2 on pole #1 phase #3 on pole #2

Power units EPU

| Phase leg | amps | volts | watts |
|---|---|---|---|
| #1 | 9.85 × | 103.7 = | 1021.44 |
| #2 | 9.08 × | 95.0 = | 862.6 |
| #3 | 7.24 × | 105.8 = | 765.9 |

Power generated

#1+#2+#3 watts=129.6

$$\frac{129.6}{2649.94} = 4.9 \%$$

#1+#2 watts=125.66
40

$$\frac{125.66}{1884.04} = 6.7 \%$$

#1+#3 watts=9.69

$$\frac{9.69}{1787.34} = 0.0005 as 0.05 \%$$

V. 3 poles, phase leg #1 is on pole #1, phase leg #2 is on pole #3, phase leg #3 is

Power into EPU

| Phase leg | amps | volts | watts |
|---|---|---|---|
| #1 | 10.01 × | 103.5 = | 1036.04 |
| #2 | 9.02 × | 96.1 = | 866.82 |
| #3 | 7.28 × | 106.5 = | 775.32 |
| Total = | | | 2678.18 |

Power generated

#1+#2+#3 watts=131.99=4.93%

#1+#2 watts=129.14

$$\frac{129.14}{1902.86} = 6.8 \%$$

#1+#3 watts=16

$$\frac{16}{1811.36} = 0.00088 or 0.088 \%$$

VI. Poles, hook up same as in I comparing power company neutral to ground neutral.

Power co neutral

Power into EPU

| Phase leg | amps | volts | watts |
|---|---|---|---|
| #1 | 9.01 × | 9.6 = | 864.96 |
| #2 | 7.30 × | 106 = | 773.8 |
| #3 | 9.82 × | 103.7 = | 1018.33 |
| Total = | | | 2657.09 |

Power generated

#1+#2+#3 watts=128.22
40

$$\frac{128.22}{2657.09} = 4.8 \%$$

#1+#3 watts=129.58

$$\frac{129.05}{1883.05} = 6.9 \%$$

Ground neutral

Power into EPU

| Phase leg | amps | volts | watts |
|---|---|---|---|
| #1 | 9.04 × | 97.5 = | 881.4 |
| #2 | 7.25 × | 109.2 = | 791.7 |
| #3 | 9.85 × | 104.9 = | 1033.3 |
| Total = | | | 2706.4 |

Power generated

#1+#2+#3 watts=133,88

$$\frac{133.88}{2706.4} = 4.95 \%$$

#1+#3 watts=133

$$\frac{138}{1914.7} = 6.95 \%$$

Other pole combination yielded less current flow and therefore less generated power than did the utility neutral backup.

VII. Current flow, with bypass of EPU, neutral from load coils are connected directly to ground.

| Phase lead | load resistance | amps | | |
|---|---|---|---|---|
| #1 | 4.2 ohms | 29.27 | 29.12 | 29.21 |
| #2 | 4.2 ohms | 29.13 | 29.03 | 29.06 |
| #3 | 4.2 ohms | 29.17 | 29.05 | 29.29 |

VIII. Hook up pole—each phase leg is used to power 2 group of pole coils. Therefore 12 (twelve) pole coils.

Resistance in pole group

#1 and #2—0.6 ohms

#3 and #4—0.6 ohms

#5 and #6—0.6 ohms

Resistance in circuit absent cogeneration unit

| Phase leg | ohms |
|---|---|
| #1 | 4.3 |
| #2 | 4.3 |
| #3 | 4.3 |

Resistance in entire circuit including cogeneration unit

| | |
|---|---|
| Phase #1 | 4.8 ohms |
| Phase #2 | 4.8 ohms |
| Phase #3 | 5.2 ohms |

Power into EPU

| Phase leads | amps | volts | watts |
|---|---|---|---|
| #1 | 12.31 × | 93.4 = | 1149.75 |
| #2 | 12.14 × | 94.1 = | 1142.37 |
| #3 | 12.78 × | 92.7 = | 1184.71 |
| Total = | | | 3476.83 |

Power generated

Watts=0.00 in all pole combination

IX. Parallel feed through pole windings single pass—resistance in each pole coil is 0.1 ohms.

Power out of load coils

| Phase leg | Amps | Volts |
|---|---|---|
| #1 | 28.27 | 3.9 |
| #2 | 28.29 | 5.0 |
| #3 | 28.64 | 3.9 |

Power flow into EPU

| Phase leg | Amps | Volts |
|---|---|---|
| #1 | 28.16 | 3.6 |
| #2 | 28.29 | 4.8 |
| #3 | 28.39 | 3.8 |

Power generated

No significant power generation with any pole combination

X and XI. EPU hook up using phase leads #1 and #3. Each phase lead activates 12 poles (6 groups of 2 poles). The two poles are wound in series and the 6 groups are wound in parallel. Each pole pair has a resistance 0.2 ohms.

It is demonstrated that the ground neutral which is used does not carry the same neutral load as the utility neutral.

Very minimal power was generated, at most 2 watts.

XII. EPU hook up same as in X and XI except that 2 (two) #10 AWG jumper is placed between ground neutral and utility neutral.

Equal current flow was observed in phase leads #1 and #3 unlike the above two experiments where the ground neutral was not sufficient to carry the load.

Poor power generation—Leads #1 and #3 generated 16.7 watts.

Data Summary and Interpretation

1. The data suggest that in the case of the current cogeneration unit, the best power output is when 3 phase leg #1 is used to activate poles #1 each coil group and phase leg #3 is used to activate poles #3 and each coil group. The unit generates usable power generated from the flow of neutral which is flowing to ground at an efficiency of 6-7% of the power flowing through it.

2. It is also noted that there is less impedance to ground flow when power is being taken off the power generation coils by closing the circuit to a load. The improvement in impedance is up to 30%.

3. The power utility company neutral is superior to the ground neutral used in this system. The flow of current is questionably improvement when the utility neutral and ground neutral is used.

4. The impedance is about 3 times greater when the ground neutral is routed through the cogeneration unit. The data suggest that this can be rectified by using larger magnet wire conduits for winding the pole irons. The unit should put out more power with no increased impedance. Therefore this device becomes an effective scavenger of power which is going to ground or fluxing on the neutral legs of a 3 phase “wye” connection of a 3 phase electric generator or a 3 phase electric motor.

Cogeneration unit #3 (The next generation)

Winding Formula—using same iron as was used in cogeneration unit #2.

1. Introduction pole coils

12 pole coils per phase activation lead with 60 turns per coil of #10 copper wire has a resistance of 1.0 ohms (cogeneration unit #2).

Cogeneration unit #3 will have 8 poles per phase activation lead with 60 turns per pole. If #10 copper magnet wire is used the resistance would be: 8/12×1.0 ohms=0.6666 ohms.

#10 copper magnet wire has a cross sectional area of 10.04 (kcmil)—#4 copper magnet wire has a cross sectional area of 41.7 (kcmil) or 4 times more current carrying capacity. It is desirable to reduce the resistance from 0.666 ohms to <0.1 ohms.

Therefore two (2) #4 copper magnet wire 2 (two) in band will increase the cross sectional area by a factor of 8:

$$\frac{0.666 ohms}{8} = 0.083 ohms per activation lead$$

The formula in #4 copper magnet wire 2 in hand for 60 turns.

2. Small inner induction coils #18 gauge copper magnet wire 6 groups of coils with 3 coils per group in cogeneration unit #2 generated a voltage of 346.5 volts. The desire is to decrease the voltage to 120-130 volts AC (60 cps) therefore will decrease the numbers of turns by

$$\frac{346.5}{130} = 2.66$$

$$\frac{120 turns}{2.5} = 48 turns$$

Must increase the cross sectional area by 2.5, therefore we will use #14 copper magnet wire which will increase the cross sectional area by 2.54.

The formula is 50 turners of #14 AWG copper magnet wire, one in hand.

3. Large outer induction coils 6 groups of coils with 3 coils per group in cogeneration unit #2 generated a voltage of approximately 1200 volts—coils were made of 300 turns of #18 copper magnet wire with one (1) in hand. The desire is to decrease the voltage to 220-240 volts AC (60 cps), therefore we will decrease the number of turns by

$$\frac{1200}{240} = 5.0 times$$

$$\frac{300}{5} = 60 turns$$

Now need to increase the cross sectional area by 5 times from #18 AWG to #14 will increase the cross sectional area by 2.5. Therefore if we use #14 wire with 2 in hand (increase cross sectional area by 5) and make 60 turns the desire effect will be accomplished.

The formula is 60 turns of #14 copper magnet wire with 2 in hand.

1-44. (canceled)

45. An electric power cogeneration unit for receiving and converting a current flowing in a neutral conduit of an alternating current electric power system into usable electric power, the cogeneration unit comprising:
a cogeneration unit core having a plurality of slots formed along a surface thereof; and
a plurality of electromagnetic pole irons wound with windings of the neutral conduit and inserted into respective ones of the slots of the core, the slots of the core arranged for receiving induction power generation coils,
wherein
adjacent ones of the wound electromagnetic pole irons are wound with alternating magnetic polarity and activated in a sequence creating a rotating electric field that induces a current into the induction power generation coils when the current flows in the neutral conduit, the wound electromagnetic pole irons wound such that a first impedance between the alternating current electric power system and a ground through the wound electromagnetic pole irons is low relative to a second impedance associated with a direct path through the neutral conduit to the ground.

46. The cogeneration unit of claim 45 wherein the cogeneration unit core further comprises a metal material on the external surface of the core.

47. The cogeneration unit of claim 46 wherein the metal material is a laminate sheet that is shaped onto the core.

48. The cogeneration unit of claim 46 wherein the metal material includes one of insulation coated electrical steel M-15 and insulation coated electrical steel M-19 having a thickness of one of 29-gauge and 26-gauge.

49. The cogeneration unit of claim 45, wherein a shape of the core includes one of a circular shape and a linear shape.

50. The cogeneration unit of claim 45, wherein the core comprises 36 wire slots.

51. The cogeneration unit of claim 45, wherein the core comprises a plurality of wire slots on an inner radius surface of the core.

52. The cogeneration unit of claim 45, wherein the core comprises a plurality of wire slots on an outer radius surface of the core.

53. The cogeneration unit of claim 45, wherein the core is supported by a support means.

54. The cogeneration unit of claim 45, wherein connection of the induction power generation coils is configured to allow the generation of one of: single phase, 2 phase and 3 phase power alternating current.

55. The cogeneration unit of claim 54 wherein alternating current is used to operate DC (direct current) equipment by routing the output from the induction power generation coils through a full wave rectifier.

56. The cogeneration unit of claim 45, wherein the core material includes a soft iron material and the wound pole iron material includes a laminated steel pole material wound in a direction with the conduit carrying the neutral load current.

57. The cogeneration unit of claim 45, wherein an end of each of the wound electromagnetic pole irons is in direct proximity to one of the induction power generation coils within the a corresponding one of the coil slots.

58. The cogeneration unit of claim 57, wherein the electromagnetic poles irons are wound with the neutral conduit such that at least two north poles are energized in sequence in a first direction over each slot associated with a first portion of the induction power generation coils.

59. The cogeneration unit of claim 58, wherein the neutral conduit traverses to and is wound on the electromagnetic pole irons embedded within the slots associated with a second portion of the induction power generation coils.

60. The cogeneration unit of claim 58, wherein the windings of the electromagnetic pole irons embedded within the slots associated with the second portion of the induction power generation coils are wound in the opposite direction in reference to the electromagnetic pole iron windings over the power generation coils associated with the first portion such that the electromagnetic pole irons embedded within the wire slots associated with the second portion are south pole wound and are energized in sequence in the first direction so as to generate power in the induction power generation coils by induction.

61. The cogeneration unit of claims 60, wherein when powering the electromagnetic pole irons, the three (3) electromagnetic poles are energized in sequence by using one of: two lines of a pulsed DC current supply; and three lines of a three (3) phase AC current supply.

62. The cogeneration unit of claim 61, wherein the sequence, in electrical degrees, of energizing the electromagnetic pole irons includes energizing the first electromagnetic pole iron, energizing the second electromagnetic pole iron about 60° later than the first electromagnetic pole iron, and energizing the third electromagnetic pole iron 60° after the energizing of the second electromagnetic pole iron.

63. The cogeneration unit in claim 62, wherein in a portion of the cogeneration core corresponding to the second 180° electrical degrees of the 3 phase cycle, the electromagnetic pole iron windings are of opposite polarity.

64. The cogeneration unit in claim 63, wherein the sequence of energizing creates a rotating magnetic field associated with a static solid state armature.

65. The cogeneration unit of claim 45, wherein, when only single phase electric power is available, an electrical phase differential between the electromagnetic pole irons is created by the use of capacitor banks.

66. The cogeneration unit of claim 65, wherein single phase neutral current is fed to adjacent ones of the electromagnetic pole irons fed from the same single phase service, the current passed through a capacitor bank such that the voltage and current are retarded by an additional phase angle shift in one of the adjacent ones with respect to another one of the adjacent ones.

67. A method of electric power cogeneration unit for receiving and converting a current flowing in a neutral conduit of an alternating current electric power system into usable electric power, the method comprising:
providing a cogeneration unit core having a plurality of slots formed along a surface thereof; and
arranging a plurality of electromagnetic pole irons wound with windings of the neutral conduit and inserted into respective ones of the slots of the core, the slots of the core arranged for receiving induction power generation coils,
wherein
adjacent ones of the wound electromagnetic pole irons are wound with alternating magnetic polarity and activated in a sequence creating a rotating electric field that induces a current into the induction power generation coils when the current flows in the neutral conduit, the wound electromagnetic pole irons wound such that a first impedance between the alternating current electric power system and a ground through the wound electromagnetic pole irons is low relative to a second impedance associated with a direct path through the neutral conduit to the ground.

68. The method of claim 67 wherein the cogeneration unit core further comprises a metal material on the external surface of the core.

69. The method of claim 68 wherein the metal material is a laminate sheet that is shaped onto the core.

70. The method of claim 69 wherein the metal material includes one of insulation coated electrical steel M-15 insulation coated electrical steel M-19 having a thickness of one of 29-gauge and 26-gauge.

71. The method of claim 67 wherein a shape of the core includes one of a circular shape and a linear shape.

72. The method of claim 67 wherein the core comprises 36 wire slots.

73. The method of claim 67 wherein the core comprises a plurality of wire slots on an inner radius surface of the core.

74. The method of claim 67 wherein the core comprises a plurality of wire slots on an outer radius surface of the core.

75. The method of claim 67 wherein core is supported by a support means.

76. The method of claim 67 wherein connection of the induction power generation coils is configured to allow the generation of one of: single phase, 2 phase and 3 phase power alternating current.

77. The method of claim 76 wherein alternating current is used operate DC (direct current) equipment by routing the output from the induction power generation coils through a bridge rectifier (a full wave rectifier).

78. The method of claim 67 wherein the core material includes a soft iron material and the wound pole iron material includes a laminated steel pole material which are wound in a direction with the conduit carrying the neutral load current.

79. The method of claim 67 wherein an end of each of the wound electromagnetic pole irons is in direct proximity to one of the induction power generation coils within a corresponding one of the coil slots.

80. The method of claim 79, wherein the electromagnetic pole irons are wound with the neutral conduit such that at least two north poles are energized in sequence in a first direction over each slot a first portion of the induction power generation coils.

81. The method of claim 80, wherein the neutral conduit traverses to and is wound on the electromagnetic pole irons embedded within the slots associated with a second portion of the induction power generation coils.

82. The method of claim 80, wherein the winding of the electromagnetic pole irons embedded within the slots associated with a second portion of the induction power generation coils are wound in the opposite direction in reference to the electromagnetic pole iron windings over the induction power generation coils associated with the first portion such that the electromagnetic pole irons embedded within the wire slots associated with the second portion are south pole wound and also are energized in sequence in the first direction so as to generate power in the induction power generation coils by induction.

83. The method of claim 81, wherein when powering the electromagnetic pole irons, the three (3) electromagnetic poles are energized in sequence by using one of: two lines of a pulsed DC current supply; and three lines of a three (3) phase AC current supply.

84. The method of claim 83, wherein the sequence, in electrical degrees, of energizing the electromagnetic pole irons includes energizing the first electromagnetic pole iron, energizing the second electromagnetic pole iron about 60° later than the first electromagnetic pole iron, and energizing the third electromagnetic pole iron 60° after the energizing of the second electromagnetic pole iron.

85. The method in claim 84, wherein in a portion of the cogeneration core corresponding to the second 180° electrical degrees of the 3 phase cycle, the electromagnetic pole iron coils are of opposite polarity.

86. The method in claim 84, wherein the sequence of energizing creates a rotating magnetic field associated with a static solid state armature.

87. The method of claim 67, wherein, when only single phase electric power is available, an electrical phase differential between the windings of the electromagnetic pole irons is created by the use of capacitor banks.

88. The method of claim 87, wherein single phase neutral current is fed to adjacent ones of the electromagnetic pole irons fed from the same single phase service, the current passed through a capacitor bank such that the voltage and current are retarded by an additional phase angle shift in one of the adjacent ones with respect to another one of the adjacent ones.
